(19) United States
(12) Patent Application Publication
(10) Pub. No.: US 2017/0197750 A1
(43) Pub. Date: Jul. 13, 2017

(54) ERECTABLE CONTAINER, BLANK AND METHOD

(71) Applicant: LBP Manufacturing LLC, Cicero, IL (US)

(72) Inventors: Kurt Wolf, Chicago, IL (US); Jennifer Ehlers, Chicago, IL (US)

(21) Appl. No.: 15/399,145

(22) Filed: Jan. 5, 2017

Related U.S. Application Data
(60) Provisional application No. 62/338,628, filed on May 19, 2016.
(60) Provisional application No. 62/276,107, filed on Jan. 7, 2016.

(51) Int. Cl. B65D 5/24; B65D 5/66; B65D 5/42

(52) U.S. Cl. CPC B65D 5/244; B65D 5/4266; B65D 5/66; B31B 1/26; B31B 1/74

(57) ABSTRACT

A container blank comprising a bottom portion defined on four sides by a first, second, third, and fourth bottom score, a first side portion partially defined by the first bottom score, a second side portion partially defined by the second bottom score, a front portion partially defined by the third bottom score, a back portion defined by the fourth bottom score, a first back connecting portion connecting the first side portion to the back portion, a second back connecting portion connecting the second side portion to the back portion, a first front connecting portion connecting the first side portion to the front portion, and a second front connecting portion connecting the second side portion to the front portion. Wherein folding of the side portions about their respective bottom scores causes the back and front portions to fold about their respective bottom scores.

### CROSS REFERENCE TO RELATED APPLICATIONS

This application claims the benefit of U.S. Provisional Patent Application No. 62/338,628, filed May 19, 2016 and U.S. Provisional Patent Application No. 62/276,107, filed Jan. 7, 2016, both which are hereby incorporated by reference in their entirety.

### FIELD

The present disclosure generally relates to an erectable container and more particularly, to an erectable container for food, a blank for forming the erectable container, and a method for the same.

### BACKGROUND

Food containers are typically used for storing and serving food items to patrons after a point-of-sale. For example, quick service restaurants or coffeehouses serve sandwiches, muffins, pastries, etc., to patrons in various types and sizes of food containers. In many instances, the containers are a clamshell type of container, which have top and bottom portions connected at a hinge region. A food article is deposited into the bottom portion, whereby the top portion is closed and secured onto the bottom portion to retain and protect the article therein. Such containers are typically manufactured from a die-cut blank that is ultimately formed into a pre-constructed food container. The pre-constructed container is formed into its final size and shape by forcefully folding the die-cut blank at various locations and then permanently gluing various folded sections together. Pre-constructed containers can be stacked or nested together to allow a multiplicity of such containers to be shipped to a quick serve restaurant or coffeehouse where they are stored prior to the point of use. In many instances, the stacking or “nesting” of such containers for shipping and storage is inefficient and costly because a pre-constructed container has a defined profile that limits the number of individual containers which can be nested within a shipping box. Thus, the larger the size and shape of the pre-constructed container, the greater the cost to ship the product. A similar disadvantage of pre-constructed food containers is that they occupy a very large footprint of the storage area available within the quick serve restaurant or coffee house, thereby competing with other articles that need to be stored for the operation of the restaurant. In high-volume point-of-sales environments where thousands of food containers are dispensed each day, the storage of such pre-constructed containers presents a difficult operating problem to the restaurant or coffeehouse owner. Pre-constructed, conventional food containers other than the clamshell type will also require the use of glue or other adhesives to hold the containers walls together into their final shape and likewise, they too will experience the same problems related to shipping and storage of the containers. As mentioned, many known conventional food containers require the use of glue or other adhesives to hold the containers walls together. Unfavorably, the adhesives add material costs and related manufacturing costs to the production of the containers and those costs are passed directly onto the quick serve restaurants and coffeehouses, who pass the cost onto consumers. Furthermore, adhesives used in food packaging must be carefully selected so as comply with United States Food and Drug Administration regulations related to direct or indirect food contact and such glues are relatively expensive compared to glues that are not used in a food environment. Moreover, many adhesives used in the manufacture of conventional food containers are not compostable or recyclable even though the container material itself may be compostable and/or recyclable. Thus, it should be appreciated that the use of these types of adhesives will impact the recyclability of the food container, which may negatively affect the environment and the public perception of such food containers.

In many conventional approaches, food containers serve the single purpose of providing a food item to a patron. For example, with a clamshell container, a sandwich served within is usually enveloped rather tightly by the walls of the container such that a user is required to reach into the interior cavity or interior space of the container to remove and/or replace the food item each time he desires to eat. This process sometimes leads to various sandwich components falling out of the sandwich. If the user desires to avoid this problem by setting the food item down outside of the food container, the user's options are often a surface (such as a table) that may not be sanitary, or a napkin that may not be suitable or desirable under the circumstances

Thus, there exists a need to provide a food container package that can readily be dis-assembled or transformed into a sanitary plate for resting the food item upon. There is also the need for a food container that does not require the use of special glues to manufacture the food container. There is also a need for a food container that does not have to be manufactured and shipped as a pre-constructed container so as to improve the manufacturing, shipping and storage inefficiencies mentioned above as well as other inherent disadvantages that are experienced with pre-constructed containers.

### BRIEF DESCRIPTION OF THE DRAWINGS

FIG. 1 is a top plan view of a container in a flat configuration in accordance with a first embodiment.

FIG. 2 is a perspective view of the container of FIG. 1 with broken fold lines.

FIG. 3 is a perspective view of the container of FIG. 1 in a partially open configuration.

FIG. 4 is a perspective view of the container of FIG. 1 in a closed configuration.

FIG. 5 is a front elevational view of the container of FIG. 1 in a closed configuration.

FIGS. 6A-6B are side elevational views of the container of FIG. 1 in a closed configuration.

FIG. 7 is a top plan view of a container in a flat configuration in accordance with a second embodiment of the invention.

FIG. 8 is a perspective view of the container of FIG. 7 in a partially open configuration.

FIG. 9 is a perspective view of the container of FIG. 7 in a closed configuration.

FIG. 10 is a front elevational view of the container of FIG. 7 in a closed configuration.

FIGS. 11A-11B are side elevational views of the container of FIG. 7 in a closed configuration.

FIG. 12 is a top plan view of a paperboard container blank in a flat configuration in accordance with still another embodiment.

FIG. 13 is a perspective view of the container of FIG. 12 in a closed configuration.

FIG. 14 is a top plan view of a container in a flat configuration in accordance with still another embodiment of the invention.

FIG. 15 is a perspective view of the container of FIG. 14 in a first partially open configuration.

FIG. 16 is a perspective view of the container of FIG. 14 in a second partially open configuration.

FIG. 17 is a perspective view of the container of FIG. 14 in a third partially open configuration.

FIG. 18 is a top plan view of a container in a flat configuration in accordance with still another embodiment of the invention.

FIG. 19A is a top plan view of an alternative container blank similar to the container blank of FIG. 1.

FIG. 19B is a top plan view of an alternate form of the container blank of FIG. 19A.

FIG. 19C is a top plan view of an alternate form of the container blank of FIG. 19A.

FIG. 20 is a top plan view of an alternative container blank similar to the container blank of FIG. 7.

FIG. 21 is a top plan view of the container blank of FIG. 20 with renegade fold lines.

FIG. 22 is a top plan view of a container in a flat configuration in accordance with still another embodiment.

FIG. 23 is a top plan view of the container of FIG. 22 in a partially formed configuration.

FIG. 24 is a top plan view of the container of FIG. 22 in a partially closed configuration.

FIG. 25 is a top plan view of the container of FIG. 22 in a closed configuration.

FIG. 26 is a perspective view of the container of FIG. 22 in a closed configuration.

FIG. 27 is a cross sectional view of a cutting die and counter-plate for scoring a container blank.

FIG. 28 is a cross-sectional view of a double face substrate scored by the cutting die and counter-plate of FIG. 27.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

The exemplary embodiments described herein below are to a food container for storing and serving food items. The food containers generally comprise a square or rectangular bottom defined by four fold lines or score lines. Each of the four bottom score lines at least partially define one of the four side wall portions. The four side wall portions pivot up about the bottom score lines to form four upstanding side wall portions. The side wall portions comprise two side wall portions and two end wall portions, with the end wall portions being the front wall portion and the back wall portion. In each of the four corners there is at least one connecting segment or portion connecting a side wall with either the front or back wall at that corner. Score lines or fold lines separate the connecting portion from the side portion on one side and the front or back portion on the other side. The fold lines connecting the connecting portions from the side walls fold the opposite direction as the bottom fold lines. The side portions pivot upward about the bottom fold lines, such that the first face of the blank forms the inside corners of the resulting structure. Once folded upward, the side wall portions and end wall portions form substantially vertical walls and the connecting portions fold outwardly away from the interior of the container. When the container is formed, the connecting portions are folded such that they extend along a portion of the front or back walls and are substantially parallel thereto.

Generally, the food container is formed from a single, planar die-cut blank that forms a bottom wall, side walls, and one or more top walls. Advantageously, each of the embodiments are configured such that they do not require the use of glue to form and hold the walls of the container together as required with a fully manufactured, pre-constructed container. Moreover, an assembled container of the invention can be readily deconstructed and transformed into a substantially planar or flat state for subsequent use as a sanitary eating surface as a result of none of the walls being permanently glued and attached together. Another advantage of the disclosed embodiments is that the die-cut blanks are intentionally designed to be shipped and stored in a planar or substantially planar state and then manipulated and folded into a final food container configuration just prior to the insertion and serving of the food item. Manufacturing and shipping a flat piece of material presents a cost savings to the manufacturer and it also allows the store owner to free up storage space. The above-mentioned advantages are the result scoring the blank in certain locations thereon as described in greater detail below, allowing the blank to be folded and assembled into the final container shape without the use of glues, special machinery and formers that are used with conventional, pre-constructed containers. Likewise, because the containers described herein do not use glues and/or adhesives, the container can be readily deconstructed and transformed into a substantially planar state for use as a serving plate. In operation, each of the embodiments described herein can be erected into a fully assembled food container merely by pivoting both sidewalls in an upward direction towards the bottom wall. When either sidewall is pivoted upward, the remaining front and rear walls and remaining sidewall will automatically fold and follow the same movement of the sidewall. By folding of both sidewalls and the automatic following of the front and rear walls, the bottom part of the container will essentially assemble itself into its final configuration, ready for receipt of a food item. When the top lid of the container is locked, the entire package is structurally held together without the need for using forming aids to shape the container or glues or adhesives to hold it together.

Generally the fully formed box containers are formed of a bottom wall which has outer perimeter edges. Around the perimeter edges are a plurality of upstanding walls, including opposed front and rear walls and opposed side walls. When erected, the front and rear walls each project laterally outward beyond the side walls. At each end of the opposite side walls is a connecting portion to connect to the front wall and rear wall respectively. The upstanding walls together with the bottom wall form an interior space having an upper opening in which the food or other material is stored. One or more top walls, connected to the front and/or rear wall by fold lines, are folded to cover the upper opening and enclose the interior space. The respective connecting portions extend from the lateral ends of each of the side walls to the lateral sides of each of the front and rear walls. There is a first fold line between a connecting portion and the corresponding sidewall and a second fold line between the connecting portion and the corresponding front or rear wall. The first fold line of each connecting portion is substantially aligned with the fold line which defines the perimeter of the bottom wall along which the front/rear wall is located when the box container is in a flattened state. Because the front and rear walls laterally extend beyond the side walls, the second fold line is oblique to the first fold line, such that it extends from the corner of two perimeter edges of the bottom wall to a lateral edge of the front or rear wall. When in an erected state, the connecting portions fold substantially flat with the portions of the front and rear walls that extend past the side walls.

Although the description which follows refers to fold lines within a die-cut blank, it should be understood that each fold line represents a location on the material of the blank that will cause a folding of the blank in order to form it into the final shape of the container as described immediately above. A fold line is a pivot or rotational point of two sections of the container generally formed by scoring of the material. There are different types of scoring techniques used and the specific score types used for specific fold lines are described in greater detail below. Other advantages will be apparent upon further reading of the following description of the embodiments.

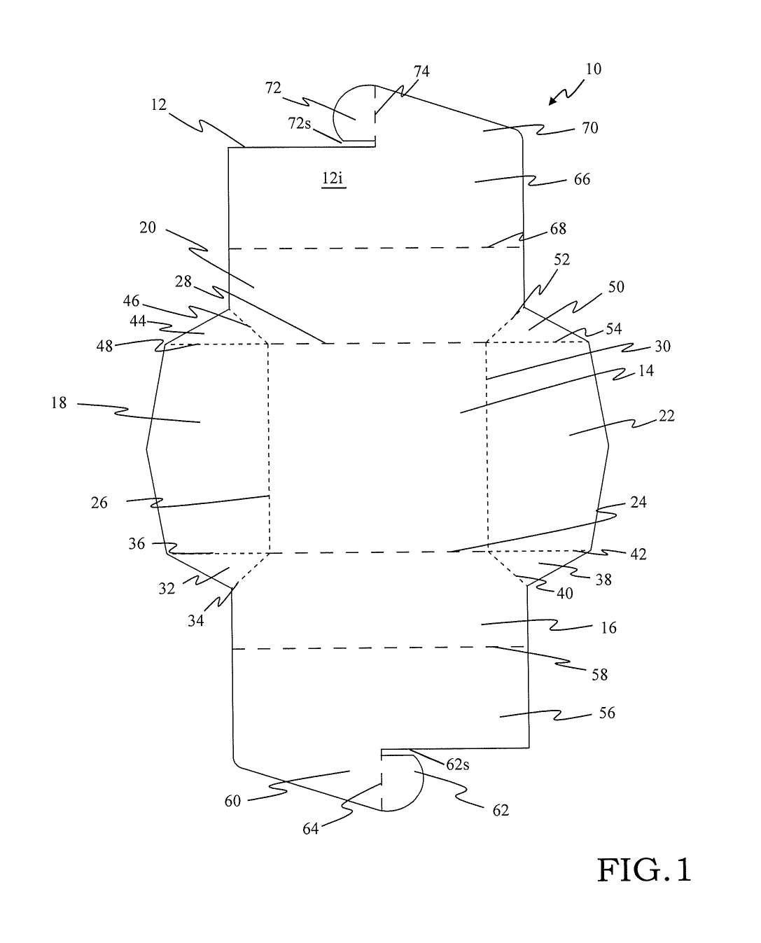

FIGS. 1-6 illustrate a first embodiment of a food container 10, of the invention. As shown in FIG. 1, the container 10 is formed from a unitary and planar die-cut blank 12, preferably of corrugated paper or of paperboard material. For example, the blank 12 may be formed of single or double faced micro-fluted sheets such as an “O”, “G”, “N”, “E” or “F” flute sheet. The inner surface 12i of the container 10 is shown in FIG. 1 is a single face of material attached to a fluted medium, with the outer surface 12t being a second face of material attached to the other side of the fluted medium. The embodiment shown is a double faced, single walled material. Other materials can be used for the containers described herein, such as a single faced and/or double walled material. In FIG. 1, the blank 12 that is shown is formed from a corrugated paper, however other materials can be used. The container 10 described herein will preferably be shipped, stored and then formed from a planar blank 12. This approach generally increases manufacturing, shipping, and/or storage efficiencies as compared to containers that are first manufactured into various types of pre-formed containers and which cannot be returned to a planar state unless the package is destroyed at the areas where the top and bottom portions are glued together.

It should also be understood that a micro-fluted material and a paperboard material have characteristics that are unique to each other and therefore will require different types of scoring in order to accomplish the folding and self-assembly feature of the invention. For example, a paperboard material has a natural grain direction which allows it to bend in one direction easier than in the other direction. With micro-fluted material on the other hand, bending in a parallel direction to the valleys of the flutes will occur very easily, whereas bending in a direction that crosses the flutes is not easily accomplished and will require certain types of scoring that may not be of the same type used with paperboard material. With each material, it has been found that certain types of scoring are better suited to that particular material rather than attempting to use a common type of scoring for each material, otherwise the unintended result is that uncontrolled and undesired folding within the blank may occur. These unintended folds which may appear in the material are known as renegade fold lines and they will be explained in greater detail later herein. Thus, in order to accomplish the self-assembly of the container of the invention without the formation of renegade fold lines, each type of material will have to be scored differently. Generally, the following types of scoring may be employed on a blank made from either type of material. Simple scoring as used herein, is defined as a limited or predetermined crushing of the material such that the crushed material will present itself as an indentation in one face of the material but not on the other. Partial cut scoring is defined as a line of knife cuts that are formed partially through the thickness of the material. Perforation scoring is defined as a line of spaced perforations that extend completely through the thickness of the material. In most instances herein, simple scoring may be also accompanied by or complimented with a series of spaced perforations that follow the scoring. Perforations are typically used when there is no concern that a liquid may leak from the interior space of the container through the perforations. When there is such a concern, only simple scoring may be employed in place of perforations.

A limitation to the type of scoring that may be employed with the present invention is related to the caliper or thickness of the paperboard or fluted material that is being used to form the blank. For example, with a fluted material, the flutes that form part of the micro-fluted material will be easily crushed so as to readily form a simple score line. With a paperboard material, the material is solid, therefor partial score cuts are used instead of simple score lines. Counter and reverse counter scoring can be used, but the paperboard may be more resistive to crushing and forming into a score line, depending upon its thickness. For example, it has been found that simple scoring of a blank formed of paperboard is not attainable when the caliper of the material is thicker than a 24 point paperboard, which is 24 mils thick. In addition, it has also been found that even though a particular caliper may tolerate crushing into a score line, the material may not readily fold or bend as desired in certain locations on the blank. Therefore, those locations may require an additional inducement to fold such as the provision of perforations within the score lines in order to overcome the inherent resistance the paper material has towards bending in certain directions, thereby allowing the container of the invention to effectively fold and self-assemble. Similarly, some characteristics of the material may require the score lines to be replaced with partial cut scores instead of simple scores accompanied by perforations.

With either a micro-fluted corrugated paper or a paperboard material, it has been found that the type of scoring needed to accomplish the self-assembly feature of the invention will be dependent upon whether the caliper is considered to be a heavyweight, medium weight or lightweight material and upon the direction that a fold line is intended, for example if the fold will be parallel to or across a flute, as was previously described. A relatively heavyweight, F-flute material may be more resistive to all forms of scoring compared to a lightweight F-flute material. Furthermore, the larger the flutes, the less tolerable they will be to more extensive forms of scoring such as counter-plate scoring, where both faces of the material will be crushed together in a single direction. Counter-plate scoring is more extensive because it also stretches the material to the point where it may tear and it has been found that the caliper of the material will define the limits of counter-plate scoring. Generally, the depth or extent to which counter-plate scoring can be provided in a material is limited to one caliper thickness of the material. Thus, a 24 point paper would likely tear if counter-plate scored to a depth that exceeded 24 mils. How a counter-plate is formed and the limitations surrounding the extent of scoring will be explained in greater detail later herein. Even when a material can tolerate counter-plate scoring, sometimes certain areas of the blank will still require complementary folding inducements such as partial cuts or perforations in order to get the container to self-assemble without the formation of renegade fold lines in those certain areas. As will be explained shortly, areas such as the short and long score lines that define each of the corner connecting portions of the blank will require this complementary treatment. Thus, paperboard made of heavyweight paper calipers (e.g., 32 caliper paper) or a heavyweight corrugated material will sometimes require additional folding inducements to complement the counter-plate scoring. Smaller caliper paperboard material (e.g., 12 caliper or 14 caliper paper) or a lightweight corrugated material may not require the same or any inducements to fold in those specific areas such that the self-assembly aspect of the invention may be possible using only simple scoring and/or simple scoring with perforations or partial cuts.

The container 10 includes a bottom wall 14, a front wall 16, a left sidewall 18, a rear wall 20, and a right sidewall 22, all walls are either directly or indirectly interconnected by fold lines or living hinges. The bottom wall 14 of the container 10 has a generally flat configuration for stably resting on a flat surface, such as a table. The front wall 16 is hingedly attached to the bottom wall 14 along a first bottom fold line 24. The left sidewall 18 is hingedly attached to the bottom wall 14 along a second bottom fold line 26. The rear wall 20 is hingedly attached to the bottom wall 14 along a third bottom fold line 28. The right sidewall 22 is hingedly attached to the bottom wall 14 along a fourth bottom fold line 30.

The front wall 16 is connected to the left sidewall 18 via a first connecting portion 32. The first connecting portion 32 is hingedly attached to the front wall 16 along a first side fold line 34, and is hingedly attached to the left sidewall 18 along a second side fold line 36. The front wall 16 is also connected to the right sidewall 22 via a second connecting portion or second connecting portion 38. The second connecting portion 38 is hingedly attached to the front wall 16 along a third side fold line 40, and is hingedly attached to the right sidewall 22 along a fourth side fold line 42.

The rear wall 20 is connected to the left sidewall 18 via a third connecting portion or third connecting portion 44. The third connecting portion 44 is hingedly attached to the rear wall 20 along a fifth side fold line 46, and is hingedly attached to the left sidewall 18 along a sixth side fold line 48. The rear wall 20 is also connected to the right sidewall 22 via a fourth connecting portion or fourth connecting portion 50. The fourth connecting portion 50 is hingedly attached to the rear wall 20 along a seventh side fold line 52, and is hingedly attached to the right sidewall 22 along an eighth side fold line 54.

A first top wall 56 is hingedly attached to the front wall 16 along a first top fold line 58. The first top wall 56 includes a first extension region 60 having a first engagement tab 62 and a first engagement slot 62s. A second top wall 66 is hingedly attached to the rear wall 20 along a second top fold line 68. The second top wall 66 includes a second extension region 70 having a second engagement tab 72 and a second engagement slot 72s. Collectively, the first and second engagement tabs and slots form a top wall locking mechanism for locking the two top walls together by engaging the opposed locking tabs into the opposed locking tab slots. In some approaches, the first engagement tab 62 is hingedly attached to the first extension region 60 along a first tab fold line 64, and/or the second engagement tab 72 is hingedly attached to the second extension region 70 along a second tab fold line 74.

The paper material from which the container blanks are die-cut will retain an inherent tendency to want to unfold and return to a pre-folded planar state after it has been folded unless the paper is held under pressure and is glued into a particular shape with the assistance of a forming fixture or other external forming aid. This tendency is referred to as the paper material as having a “memory” or an “intelligence.” The strength of this memory varies in accordance with the particular type of paper material and its caliper. The inclusion of certain types and locations of scoring lines in the above-described blank 12 overcome the “memory” or “intelligence.” That is, due to the aforementioned certain types and locations of scored fold lines, the walls of the blank 12 of the invention will no longer have a tendency to want to automatically spring out of a folded position towards a planar position after they have been folded. Thus, with the scoring in certain locations, the walls will rotate (i.e., fold) as desired and remain folded or unfolded as the scoring dictates. Due to the scored fold lines and their locations, construction of the container 10 may be performed entirely without the need to resort to a forming fixture or other external forming aids or gluing.

All of the fold lines provided in the first embodiment of the invention are standard score lines. These score lines are depressions in one face of the material of the blank and they allow the blank to be folded along the particular fold line. In FIG. 1, the depression will be formed in surface 12i and will not extend through the material to effect surface 12t. Perforations may also be applied to one or more of the fold lines of the blank 12 of the first embodiment of the invention. The inclusion of perforations on the fold line further increases the flexibility of the fold lines, which further ensures that the blank will fold without the need for a forming device or aid, thereby expediting the construction of the container 10 for the user. The perforations may be regularly spaced apart along the fold lines, for example, at 0.125 inch intervals. The perforations may pass through the entire thickness of the blank 12, or may pass through only a portion of the thickness of the blank 12. In a preferred approach, the second bottom fold line 26 and the fourth bottom fold line 30 include perforations through the entire thickness of the blank 12. A wall of blank 12 will fold cleaner along a provided fold line when it is scored perpendicularly to the direction of the flutes of a blank that is made from a corrugated material. Fold lines 26 and 30 are parallel to the direction of flutes formed in the corrugated material of the blank. Depending on the location of the blank on the sheet of material when die cut, a fold line may be formed in the peak of a flute such that when it is to be folded, a valley next to that peak will dominate over the inscribed fold line in the peak such that the blank will actually fold along the valley rather than in the fold line of the peak. To reduce the likelihood of the valley dominating over the fold line, the first bottom fold line 24 and the third bottom fold line 28 may include perforations through the thickness of the blank 12. Other combinations of fold lines and perforations are possible.

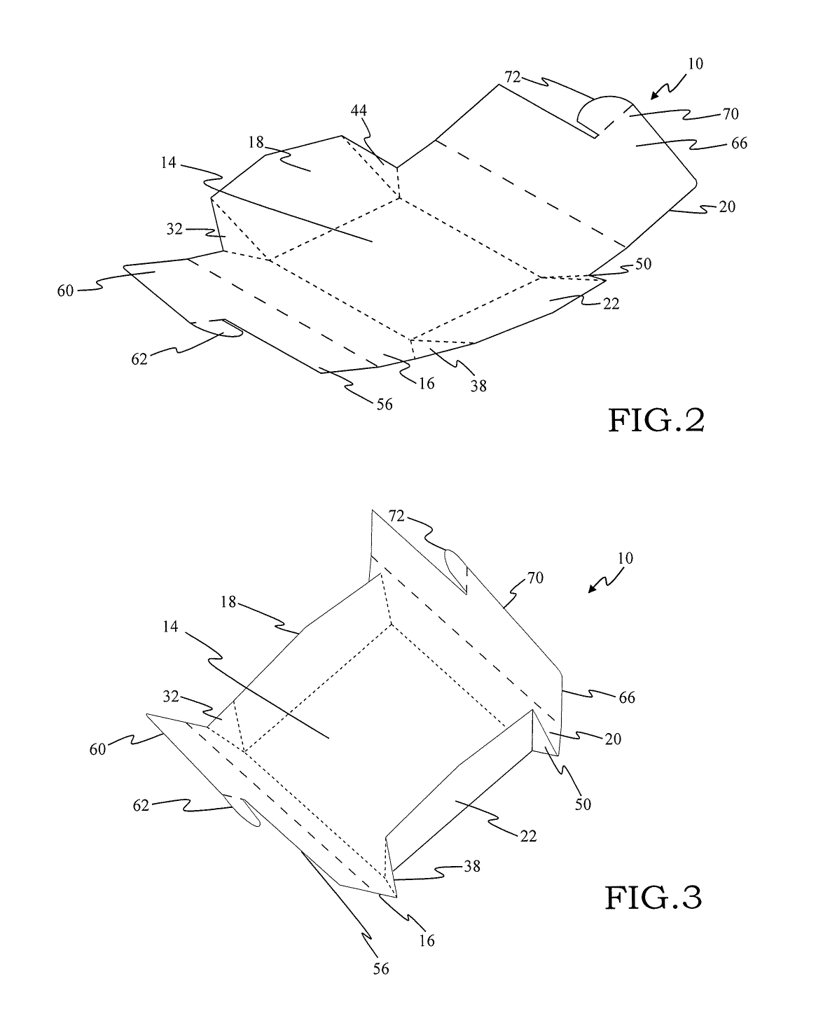

To substantially increase the likelihood that the material of the blank 12 folds along intended score lines, especially when a fold line is running parallel to the direction of the flutes within the blank, some of the fold lines may be “pre-broken” prior to shipping. The pre-breaking of the fold lines may be performed in-line during manufacture of the blank 12. In this way, certain areas of the blank 12 are partially folded about their respective fold lines, as shown for example in FIG. 2. The pre-breaking of fold lines also decreases the likelihood that a renegade fold line will appear when the blank is assembled into a finished container, as will be described later herein. In alternative embodiments, the fold lines are not pre-broken.

Advantageously, due to the aforementioned configuration of the blank 12, the pivoting of both of the side walls with respect to the bottom wall automatically effects the pivoting of the front and back walls with respect to the bottom wall. This automatic response of all walls to rotate in the same inward direction is the result of the scoring overcoming the inherent paper memory, which in turn, causes each wall to rotate in unison if it is connected to an adjacent wall through a respective connecting portion. Thus, for example, as the front wall 16 is pivoted or pushed upwardly about first bottom fold line 24 towards the bottom wall, then the front wall 16 pulls the first connecting portion connecting portion 32 from a flat position to an upright position. First connecting portion connecting portion 32, also being connected to left sidewall 18, in turn, simultaneously pulls left sidewall 18 from a flat position to an upright position. Likewise, the front wall 16 also simultaneously pulls on the second connecting portion connecting portion 38, which in turn, pulls the right sidewall 22 from a flat position to an upright position since the second connecting portion connecting portion 38 is also connected to the right sidewall 22. Furthermore, left sidewall 18 and right sidewall 22, in turn, pull the rear wall 20 from a flat position to an upright position via the third connecting portion 44 and the fourth connecting portion 50, respectively, in a similar fashion and for the same reasons. Thus, the simultaneous interaction of the walls will result due to connecting portions and the score lines of the blank 12 so as to automatically construct that part of the container 10 for the user, as best seen in FIG. 3.

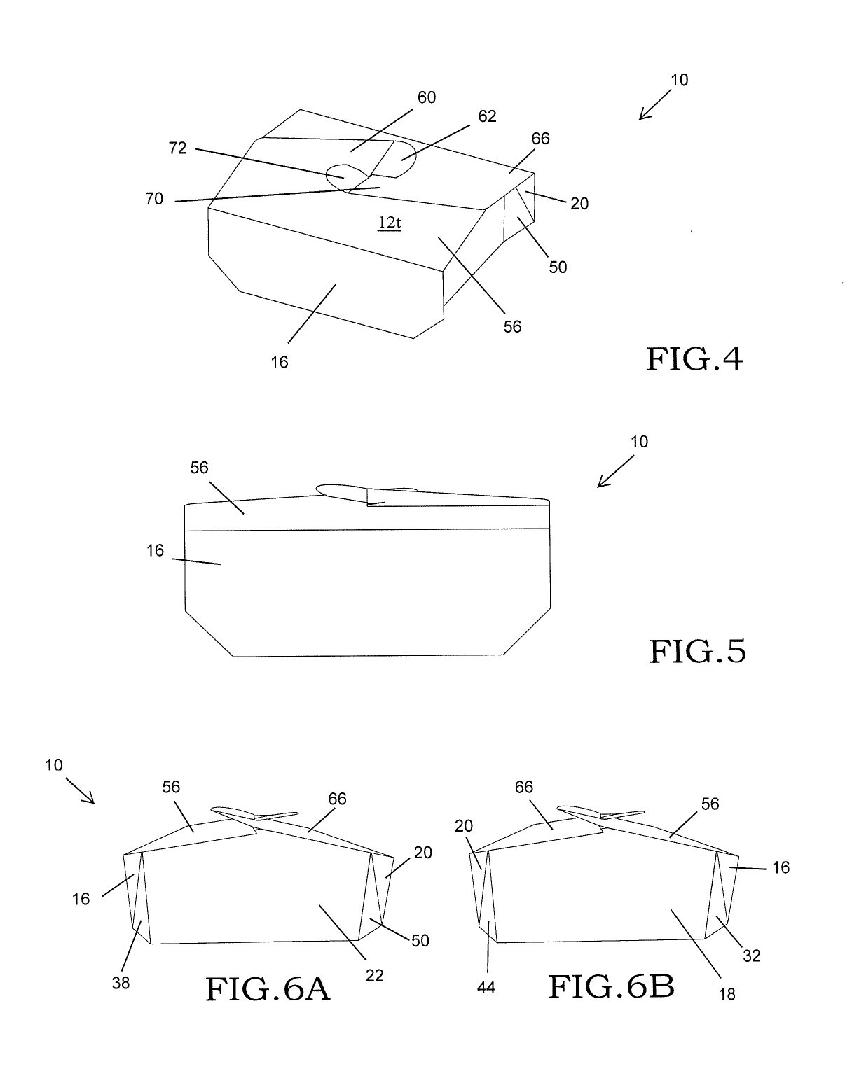

In the closed configuration, shown in FIGS. 4-6B, it is seen that the front wall 16, left sidewall 18, rear wall 20, and right sidewall 22 extend generally perpendicularly from the bottom wall 14 so as to have a vertical, upright configuration. In this closed configuration, the first extension region 60 of the first top wall 56 overlaps the second top wall 66, and the second extension region 70 of the second top wall 66 overlaps the first top wall 56. To secure the container 10 in the closed configuration, the first engagement tab 62 is brought into engagement with the second engagement tab 72 via tabs 62, 72 being inserted in opposed insertion slots 72s, 62s. Advantageously, the first engagement tab 62 and the second engagement tab 72 allow the container 10 to be repeatedly opened and closed.

In the closed configuration best seen in FIGS. 6A-6B, the first connecting portion 32 is disposed substantially parallel to the front wall 16, and substantially perpendicular to the left sidewall 18. Similarly, the second connecting portion 38 is disposed substantially parallel to the front wall 16, and substantially perpendicular to the right sidewall 22. The third connecting portion 44 is disposed substantially parallel to the rear wall 20, and substantially perpendicular to the left sidewall 18. Similarly, the fourth connecting portion 50 is disposed substantially parallel to the rear wall 20, and substantially perpendicular to the right sidewall 22.

Advantageously, due to the aforementioned configuration of the scoring of blank 12, the container 10 is maintained in the closed configuration, shown in FIGS. 4-6B, without the use of an applied adhesive material. That is, both the top and bottom portions that are formed from the blank 12 are free of adhesive material. By eliminating the need for adhesives, material costs and manufacturing costs are significantly reduced. Furthermore, the adhesive-free container 10 is more environmentally friendly as compared to other containers that require adhesives.

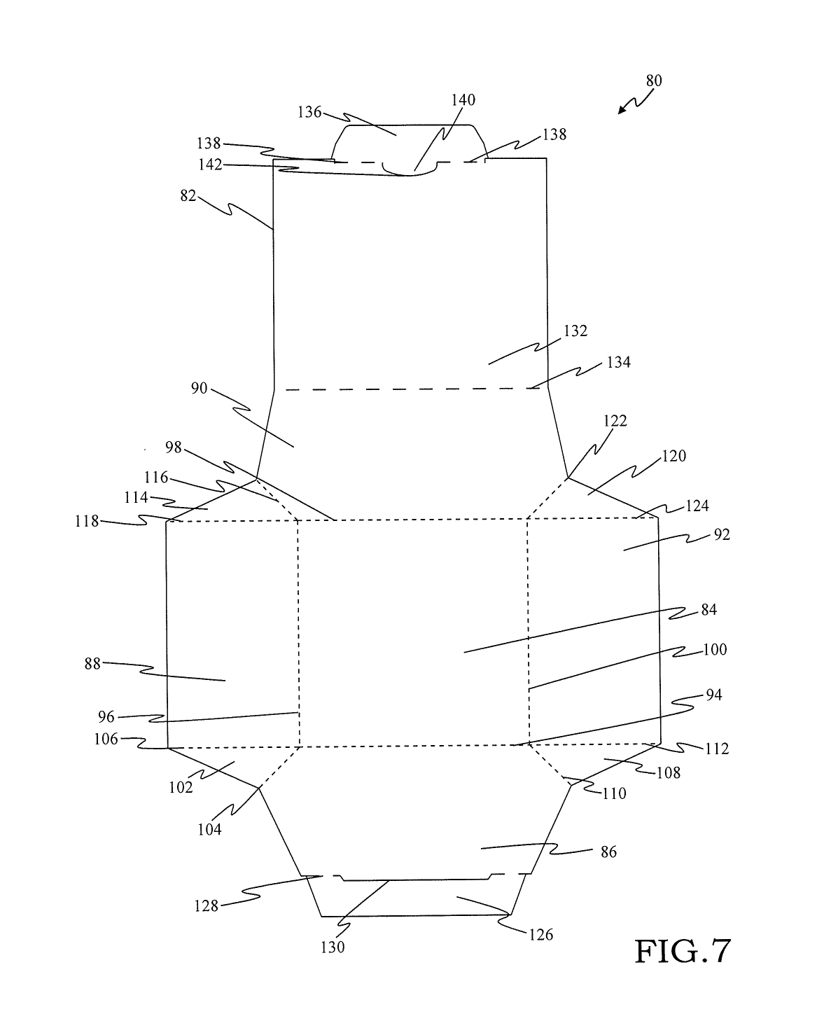

In one approach seen in FIGS. 6A and 6B, where the assembled container is provided with two top interlocking walls, left sidewall 18 and right sidewall 22 each have a five-sided profile in the assembled configuration where first top wall 56 and second top wall 66 are angled with respect to the bottom wall 14. In a different approach shown in FIGS. 7-11B, the left sidewall and right sidewall have a rectangular profile in an assembled state, such that the top wall is parallel with respect to the bottom wall. Other side wall configurations are possible.

In the closed configuration, the container 10 is suitable for storing food items and serving the same to an end user. An end user seeking to open the container 10 to access a food item simply disengages the first engagement tab 62 and the second engagement tab 72, from the engagement slots 62s, 72s, thereby allowing the container 10 to be moved from the closed position to the open position. Because no adhesive material is used throughout the container, none of the walls of the container are rigidly secured to each other and as such, the container 10 can be easily disassembled and transformed from an erected or opened container to a substantially flat or planar serving plate by pushing and depressing all of the walls flat. Because the inherent memory of the paper material is no longer present, the paper will remain planar and thus transformed.

Once in the open and transformed position, the container 10 provides the additional advantage of serving as a flat, sanitary eating surface. In this way, a user need not rest the food item on another surface (such as a table) that may not be sanitary. The flat and transformed container 10 also provides a surface for supporting other food items or condiments that a user does not wish to place on a table surface or napkin, such as French fries or catsup. Furthermore, because the transformed container 10 is flat, a user is provided easy access to the food items, as compared to most other permanently constructed containers.

FIGS. 7-11B illustrate a second embodiment of a food container 80, of the invention. As will be apparent, many of the features and attributes of the container 10 of the first embodiment are applicable to the container 80 of the second embodiment, and may not be repeated for the sake of brevity.

As shown in FIG. 7, the container 80 is formed from a single unitary blank 82, preferably of corrugated paper of the types previously described or of paperboard. The container 80 includes a bottom wall 84, a front wall 86, a left sidewall 88, a rear wall 90, and a right sidewall 92, all walls directly or indirectly interconnected by fold lines or living hinges. The bottom wall 84 of the container 80 has a generally flat configuration for stably resting on a flat surface, such as a table. The front wall 86 is hingedly attached to the bottom wall 84 along a first bottom fold line 94. The left sidewall 88 is hingedly attached to the bottom wall 84 along a second bottom fold line 96. The rear wall 90 is hingedly attached to the bottom wall 84 along a third bottom fold line 98. The right sidewall 92 is hingedly attached to the bottom wall 84 along a fourth bottom fold line 100.

In one approach, each bottom fold line 94, 96, 98, 100 includes perforations through the thickness of the blank 80. The perforations may be regularly or irregularly spaced along the fold lines 94, 96, 98, 100. Other combinations of fold lines and perforations are possible.

The front wall 86 is connected to the left sidewall 88 via a first connecting portion 102. The first connecting portion 102 is hingedly attached to the front wall 86 along a first side fold line 104, and is hingedly attached to the left sidewall 88 along a second side fold line 106. The front wall 86 is also connected to the right sidewall 92 via a second connecting portion 108. The second connecting portion 108 is hingedly attached to the front wall 86 along a third side fold line 110, and is hingedly attached to the right sidewall 92 along a fourth side fold line 112.

The rear wall 90 is connected to the left sidewall 88 via a third connecting portion 114. The third connecting portion 114 is hingedly attached to the rear wall 90 along a fifth side fold line 116, and is hingedly attached to the left sidewall 88 along a sixth side fold line 118. The rear wall 90 is also connected to the right sidewall 92 via a fourth connecting portion 120. The fourth connecting portion 120 is hingedly attached to the rear wall 90 along a seventh side fold line 122, and is hingedly attached to the right sidewall 92 along an eighth side fold line 124. A closing flap 126 is hingedly attached to the front wall 86 along a first fold line 128. An insertion slot 130 is disposed between the front wall 86 and the closing flap 126.

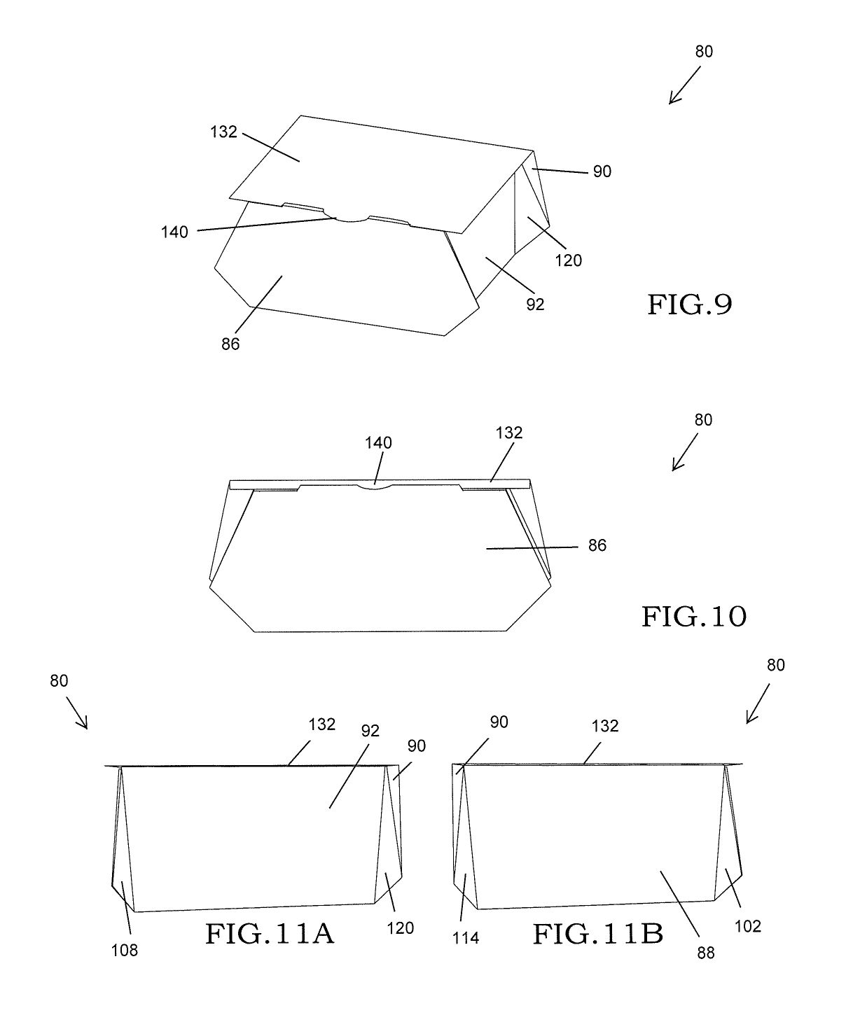

A top wall 132 is hingedly attached to the rear wall 90 along a second fold line 134. The top wall 132 includes an insertion flap 136 hingedly attached to the top wall 132 along a third fold line 138. In a preferred approach, the top wall further includes a tab 140. Insertion flap 136 is inserted into slot 130 to close and lock the top portion of the container to the bottom portion, as best seen in FIG. 9. Although container 80 is shown with a single insertion flap 136 and a single insertion slot 130, multiple insertion flaps and insertion slots are possible.

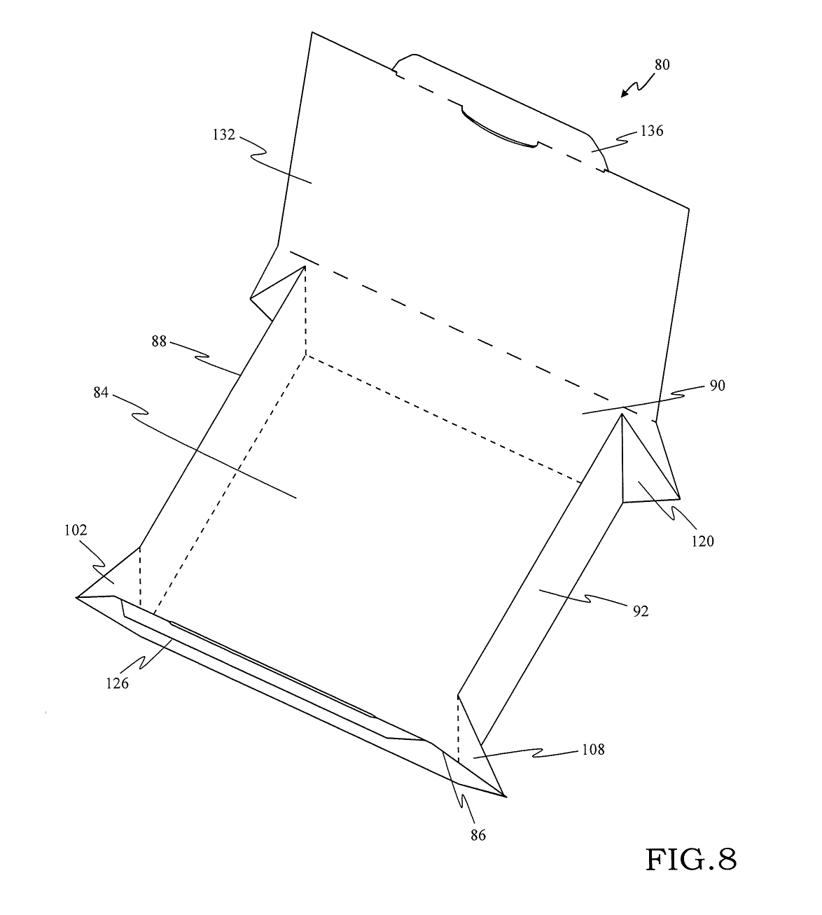

In the partially closed configuration, shown in FIG. 8, each of the front wall 86, left sidewall 88, rear wall 90, and right sidewall 92 extend generally perpendicularly upward from the bottom wall 84 so as to have a vertical, upright configuration. To secure the top wall 132 in the closed position, the insertion flap 136 is folded such that it is substantially perpendicular to the top wall 132. The closing flap 126 is folded inwardly such that it is parallel the bottom surface 84. Folding the closing flap 126 creates a spacing at the insertion slot 130 between the front wall 86 and the closing flap 126. As the top wall is closed, the insertion flap 136 is slid into the spacing at the slot 130. The tab 140 allows a user to manipulate the top wall 132 by pulling it open when the container 80 is in the closed configuration.

In the closed configuration, the first connecting portion 102, best seen in FIG. 11B, is disposed substantially parallel to the front wall 86, and substantially perpendicular to the left sidewall 88. Similarly, the second connecting portion 108, best seen in FIG. 11A, is disposed substantially parallel to the front wall 86, and substantially perpendicular to the right sidewall 92. The third connecting portion 114, seen in FIG. 11B, is disposed substantially parallel to the rear wall 90, and substantially perpendicular to the left sidewall 88. Similarly, the fourth connecting portion 120, seen in FIG. 11A, is disposed substantially parallel to the rear wall 90, and substantially perpendicular to the right sidewall 92.

Similar to container 10 of the first embodiment, container 80 is configured such that upwardly pushing both side walls of the container 10 with respect to the bottom wall 84 causes pivoting of the front and rear walls with respect to the bottom wall 84. Furthermore, no glue is necessary to maintain any part of the container 80 in the finally-constructed form. Container 80 is also configured such that it is easily disassembled and transformed into a flat sheet for subsequent use as a sanitary eating surface. Other advantages of the container 10 of the first embodiment are similarly applicable to container 80.

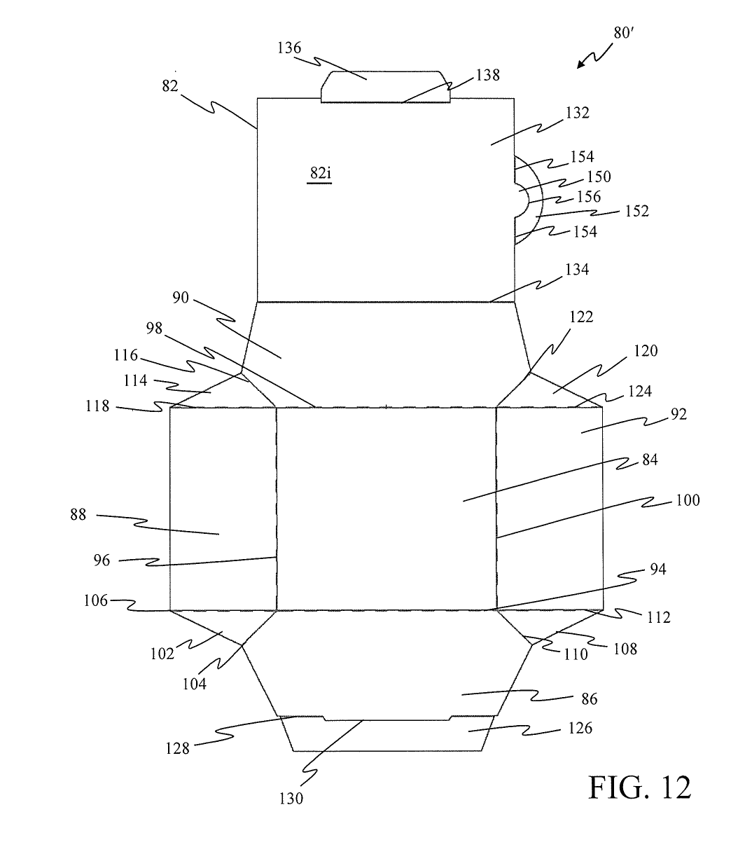

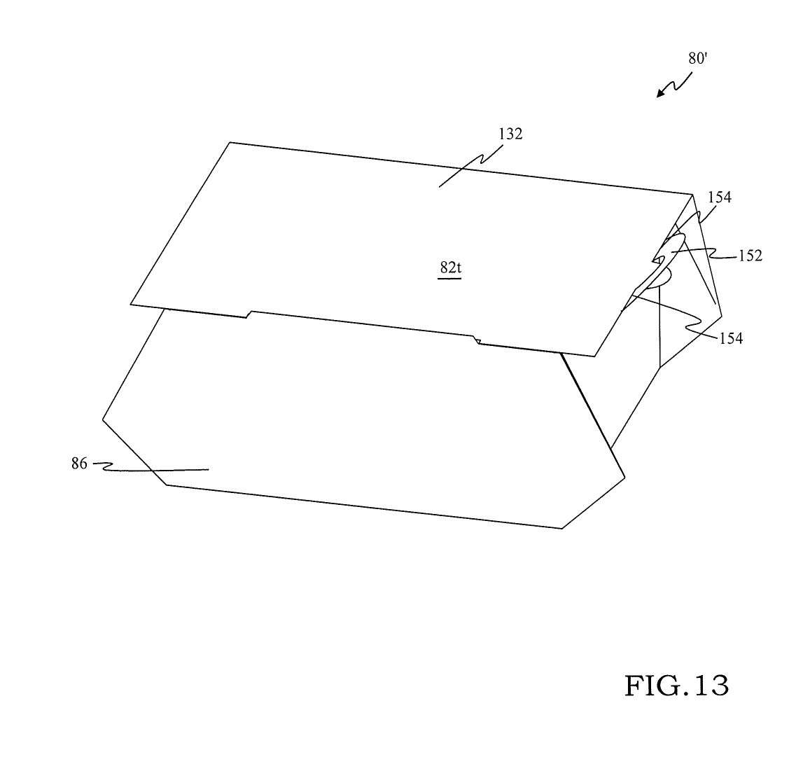

FIGS. 12 and 13 illustrate a third embodiment of a container 80′ that is formed from a blank which is comprised of a paperboard material. Paperboard is a stronger material that is more resistant to folding compared to a corrugated material. Therefore, many of the fold lines of this blank will either be accompanied with perforations or partial cuts which extend at least partially through the thickness of the material in order to facilitate folding of the walls. In view of the similarity between the second and third embodiments, the features of the container 80′ of the third embodiment that are identical to the features of the container 80 of the second embodiment are provided the same reference numerals as the features of the second embodiment. Moreover, the descriptions of the features of the container 80′ of the third embodiment that are identical to the features of the container 80 of the second embodiment may not be repeated for the sake of brevity.

As shown in FIG. 12, the container 80′ includes a bottom wall 84, a front wall 86, a left sidewall 88, a rear wall 90, and a right sidewall 92, all walls directly or indirectly interconnected by fold lines or living hinges. The bottom wall 84 of the container 80′ has a generally flat configuration for stably resting on a flat surface, such as a table. The front wall 86 is hingedly attached to the bottom wall 84 along a first bottom fold line 94. The left sidewall 88 is hingedly attached to the bottom wall 84 along a second bottom fold line 96. The rear wall 90 is hingedly attached to the bottom wall 84 along a third bottom fold line 98. The right sidewall 92 is hingedly attached to the bottom wall 84 along a fourth bottom fold line 100. The first, second, third and fourth bottom fold lines are partial cut lines where the cuts extend through surface 82t but not all the way through to surface 82i.

The front wall 86 is connected to the left sidewall 88 via a first connecting portion 102. The first connecting portion 102 is hingedly attached to the front wall 86 along a first side fold line 104, and is hingedly attached to the left sidewall 88 along a second side fold line 106. The front wall 86 is also connected to the right sidewall 92 via a second connecting portion 108. The second connecting portion 108 is hingedly attached to the front wall 86 along a third side fold line 110, and is hingedly attached to the right sidewall 92 along a fourth side fold line 112. The first and second side fold lines as well as the third and fourth side fold lines are standard score lines that are also perforated, with the perforations spaced as with the second embodiment of the invention described in FIGS. 7-11B but such that the perforations extend all the way through the material, from surface 12i to 12t.

The rear wall 90 is connected to the left sidewall 88 via a third connecting portion 114. The third connecting portion 114 is hingedly attached to the rear wall 90 along a fifth side fold line 116, and is hingedly attached to the left sidewall 88 along a sixth side fold line 118. The rear wall 90 is also connected to the right sidewall 92 via a fourth connecting portion 120. The fourth connecting portion 120 is hingedly attached to the rear wall 90 along a seventh side fold line 122, and is hingedly attached to the right sidewall 92 along an eighth side fold line 124. The fifth and sixth side fold lines as well as the seventh and eighth side fold lines are scored exactly like the first through fourth scores lines.

A closing flap 126 is hingedly attached to the front wall 86 along a first fold line 128. An insertion slot 130 is disposed between the front wall 86 and the closing flap 126. A top wall 132 is hingedly attached to the rear wall 90 along a second fold line 134. The top wall 132 includes an insertion flap 136 hingedly attached to the top wall 132 along a third fold line 138.

As shown in FIG. 12, the top wall 132 of the container 80′ includes an extension tab 150 extending from an edge of the top wall 132. A retainer 152 is hingedly attached to the top wall 132 by retainer fold lines 154. The retainer 152 is separated from the extension tab 150 by a retainer cut line 156 that extends through the material from surface 82i to 82t.

As shown in FIG. 13, the retainer 152 may be folded about the retainer fold lines 154. This creates a gap between the retainer 152 and the extension tab 150. When the container 80′ is in the closed configuration, an object such as a utensil may be inserted into the gap. The object may then rest on the top wall 132, with a portion of the object retained between the extension tab 150 and the retainer 152.

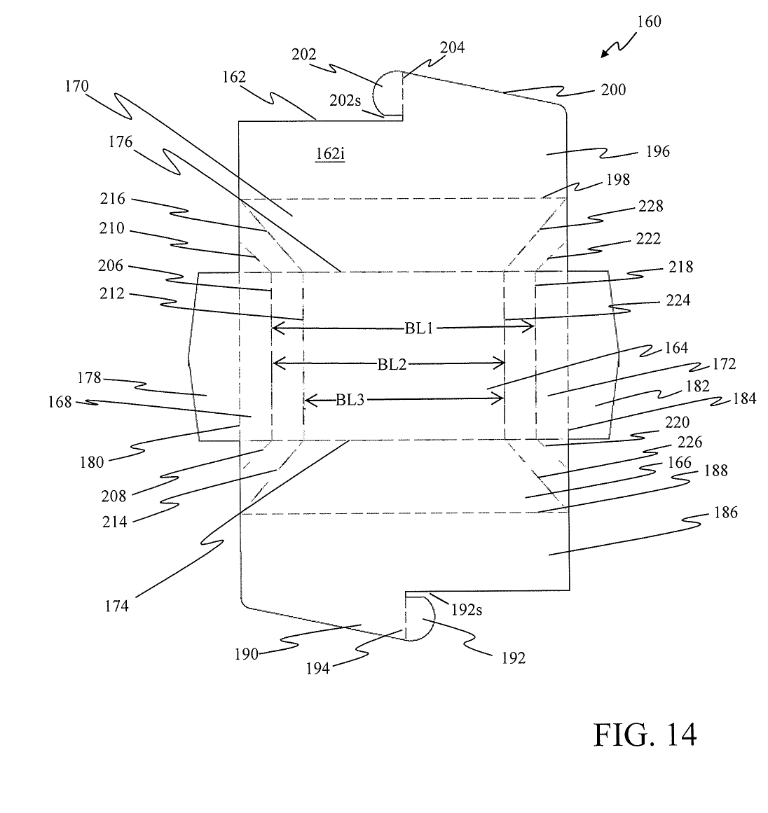

FIGS. 14-17 illustrate a fourth embodiment, hereinafter referred to as the container 160. Container 160 is a multi-configurable container. As will be apparent, many of the features and attributes of the previous three embodiments are applicable to the container 160, and may not be repeated for the sake of brevity.

As shown in FIG. 14, the container 160 is formed from a single unitary blank 162, preferably of corrugated paper of the types previously described or of paperboard. The container 160 includes a bottom wall 164, a front wall 166, a left sidewall 168, a rear wall 170, and a right sidewall 172 interconnected by fold lines or living hinges. The bottom wall 164 of the container 160 has a generally flat configuration for stably resting on a flat surface, such as a table. The front wall 166 is hingedly attached to the bottom wall 164 along a first bottom fold line 174. The rear wall 170 is hingedly attached to the bottom wall 164 along a second bottom fold line 176. In one approach, the first bottom fold line 174 and the second bottom fold line 176 are standard score lines that include perforations. The perforations extend through the material of the blank, from surface 162i through 162t. If the blank is comprised of a paperboard material, the fold lines would be formed as partial cuts. The remaining fold lines in the blank may be score lines, score lines with perforations, partial cuts or combinations thereof.

The left sidewall 168 has an upper left sidewall portion 178 hingedly attached to the left sidewall 168 along a left sidewall fold line 180. Similarly, right sidewall 172 has an upper right sidewall portion 182 hingedly attached to the right sidewall 172 along a right sidewall fold line 184.

A first top wall 186 is hingedly attached to the front wall 166 along a first top fold line 188. The first top wall 186 includes a first extension region 190 having a first engagement tab 192 and first engagement slot 192s. In some approaches, the first engagement tab 192 is hingedly attached to the first extension region 190 along a first tab fold line 194.

A second top wall 196 is hingedly attached to the rear wall 170 along a second top fold line 198. The second top wall 196 includes a second extension region 200 having a second engagement tab 202 and second engagement slot 202s. In some approaches, the second engagement tab 202 is hingedly attached to the second extension region 200 along a second tab fold line 204.

The container 160 is a multi-configurable container such that various combinations of folds can produce various container dimensions. This is accomplished by providing multiple fold lines that permit portions of the blank 162 to remain as part of the bottom wall 164, or to fold up as part the left sidewall 168 or the right sidewall 172. With this approach, the first bottom fold line and the second bottom fold line may be identically scored with score lines, score lines with perforations, partial cuts or combinations thereof.

More specifically, the blank 162 is provided with a first left fold line 206 and corresponding first front left fold line 208 and first rear left fold line 210. The blank 162 is further provided with a second left fold line 212 and corresponding second front left fold line 214 and second rear left fold line 216. The blank 162 is further provided with a first right fold line 218 and corresponding first front right fold line 220 and first rear right fold line 222. The blank 162 is further provided with a second right fold line 224 and corresponding second front right fold line 226 and second rear right fold line 228.

With this approach, all of the fold lines of the blank that were mentioned immediately above are preferably score lines with accompanying perforations. If the blank is comprised of a paperboard material, the fold lines would be provided as partial cuts. The remaining fold lines in the blank are score lines, score lines with perforations, partial cuts, or combinations thereof.

In a first configuration of this embodiment, shown in FIG. 15, the bottom portion of the container 160 is formed when the first sidewall 168 is upwardly pushed along the left fold line 206 towards the bottom wall 164. Both of these walls are upwardly pushed along the first right fold line 218 towards the bottom wall 164 such that the left sidewall 168 and right sidewall 172 are each pushed upwardly from a flat position to a substantially upright position. Pushing the left sidewall 168 upwardly about the first left fold line 206 in turn causes the respective connecting portion to fold at the first front left fold line 208 and first rear left fold line 210. Pushing the right sidewall 172 upwardly about the first right fold line 218 in turn causes the respective connecting portion to fold at the first front right fold line 220 and first rear right fold line 222. Simultaneous manipulation of the left and right sidewalls will cause the remaining front and back walls and their respective connecting portions to automatically form themselves into a partially assembled container bottom portion. This results in a first container bottom length (indicated as BL1 in FIG. 14). For example, a container 160 in the first configuration may have a bottom length of 6.25 inches. If front wall 166 and back walls 170 are initially pushed upwardly towards the bottom wall 164 instead of the sidewalls being pushed, the automatic assembly of the bottom portion of the container will not occur as walls 166 and 170, will only fold upwardly along fold lines 174 and 176.

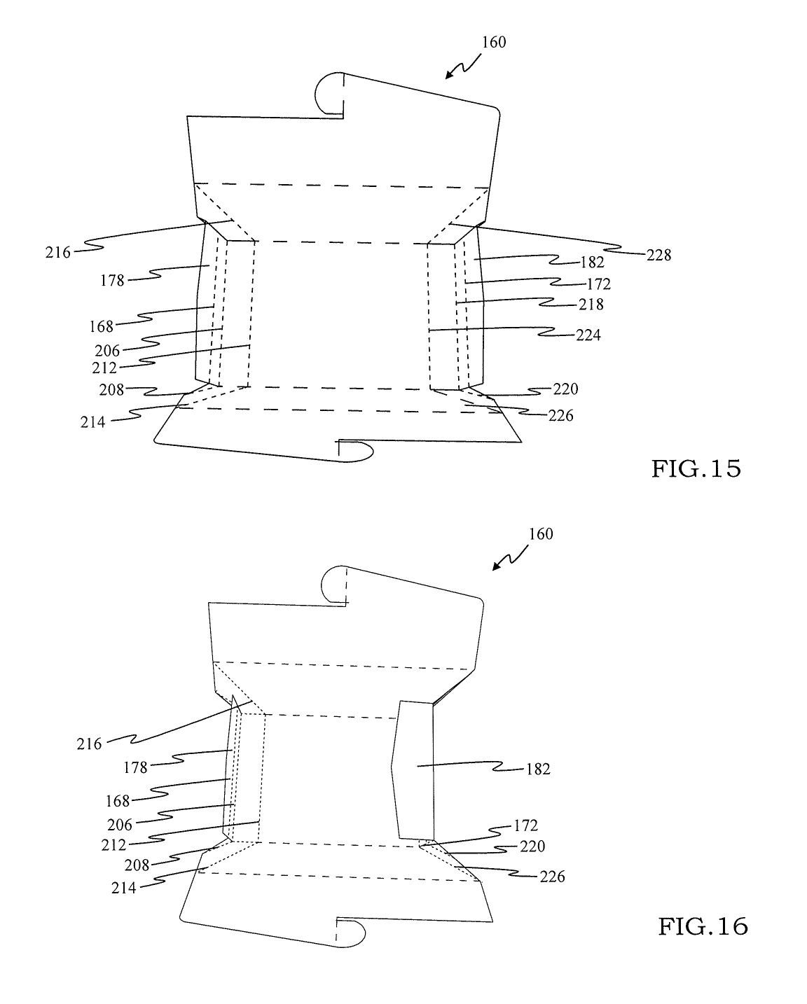

In a second configuration of this embodiment, shown best in FIG. 16, the container 160 is formed after the first sidewall 168 and the second sidewall 172 are upwardly pushed along the first left fold line 206 and the second right fold line 224 such that the left sidewall 168 and right sidewall 172 are each pushed upwardly from a flat position to an upright position. Pushing the left sidewall 168 upwardly about the first left fold line 206 in turn causes the respective connecting portion to fold at the first front left fold line 208 and first rear left fold line 210. Pushing the right sidewall 172 upwardly about the second right fold line 224 in turn causes the respective connecting portion to fold at the second front right fold line 226 and second rear right fold line 228. This results in a second container bottom length (indicated as BL2 in FIG. 14). For example, a container 160 in the second configuration may have a bottom length of 5.5 inches. A relatively shorter bottom length is dictated by the provision of taller sidewalls and taller front and back walls compared to the height of the same walls in the previous configuration.

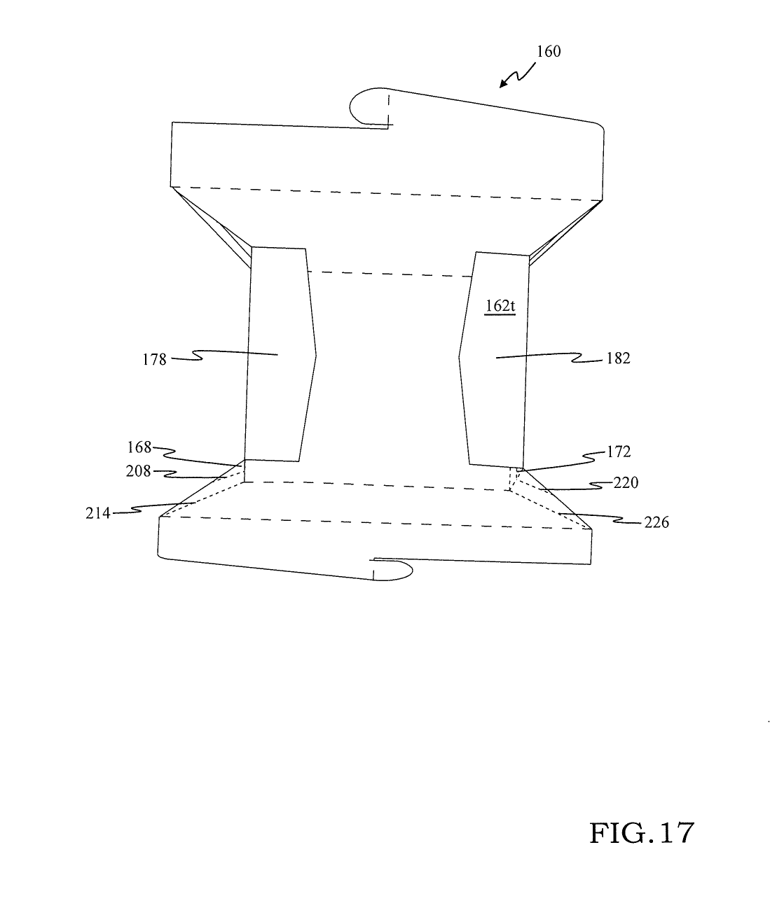

In a third configuration, shown in FIG. 17, the container 160 is formed after the first sidewall 168 and the second sidewall 172 are folded along the second left fold line 212 and the second right fold line 224 such that the left sidewall 168 and right sidewall 172 are each pushed upwardly from a flat position to an upright position. Pushing the left sidewall 168 upwardly about the second left fold line 212 in turn causes the respective connecting portion to fold at the second front left fold line 214 and second rear left fold line 216. Pushing the right sidewall 172 upwardly about the second right fold line 224 in turn causes the respective connecting portion to fold at the second front right fold line 226 and second rear right fold line 228. This results in a third container bottom length (indicated as BL3 in FIG. 14). For example, a container 160 in the third configuration may have a bottom length of 4.75 inches. The even shorter bottom length is dictated by the provision of even taller sidewalls and taller front and back walls compared to the height of the same walls in the previous configuration.

As shown and described above, the container 160 of the invention may be a multi-configurable container that can be folded into various configurations that have different lengths and heights. The container blank 162 as scored, provides versatility in a single container since it can accommodate food items of varying sizes without the need to purchase a dedicated food container size for each size of food item. Likewise, a multi-configurable container reduces the need to store different container sizes. In effect, this type of container provides an efficient approach to purchasing and storing food containers. For example, the container 160 provides an operating efficiency to a quick service restaurant through stocking a single container that is useful for food items of various lengths and heights.

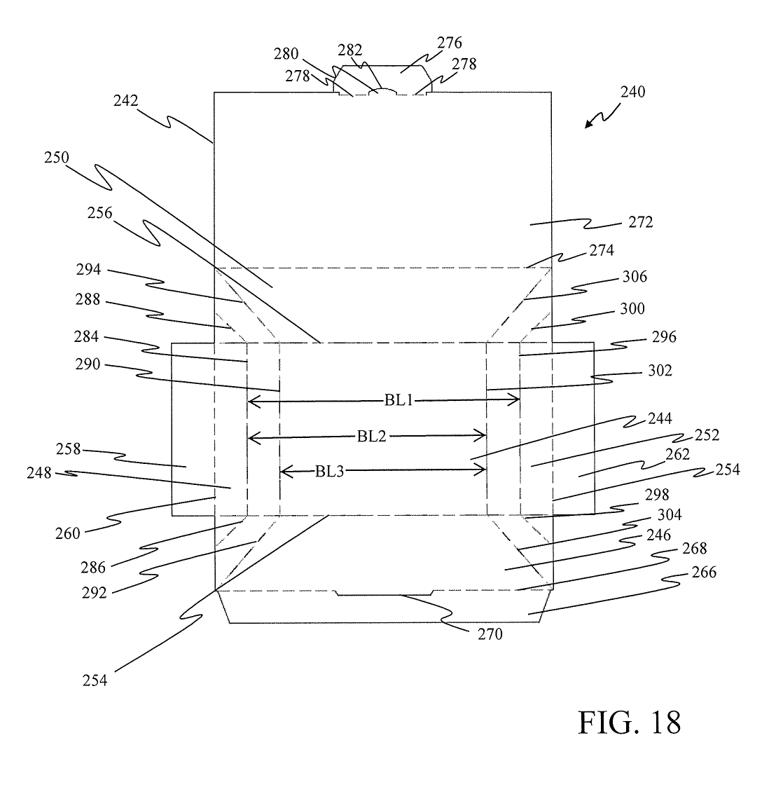

FIG. 18 illustrates a fifth embodiment of a food container 240. Similar to the container 160 of the fourth embodiment, container 240 is a multi-configurable container. As will be apparent, many of the features and attributes of the previous four embodiments are applicable to the container 240, and may not be repeated for the sake of brevity.

As shown in FIG. 18, the container 240 is formed from a single, unitary blank 242 that is die-cut from single or double faced microfluted sheets or paperboard as previously described above. The container 240 includes a bottom wall 244, a front wall 246, a left sidewall 248, a rear wall 250, and a right sidewall 252, wherein all of the walls are directly or indirectly interconnected by fold lines or living hinges. The bottom wall 244 of the container 240 has a generally flat configuration for stably resting on a flat surface, such as a table. The front wall 246 is hingedly attached to the bottom wall 244 along a first bottom fold line 254. The rear wall 250 is hingedly attached to the bottom wall 244 along a second bottom fold line 256. With this approach, the first bottom fold line 254 and the second bottom fold line 256 may be identically scored with score lines, score lines with perforations, partial cuts or combinations thereof.

The left sidewall 248 has an upper left sidewall portion 258 hingedly attached to the left sidewall 248 along a left sidewall fold line 260. Similarly, right sidewall 252 has an upper right sidewall portion 262 hingedly attached to the right sidewall 252 along a right sidewall fold line 254.

A closing flap 266 is hingedly attached to the front wall 246 along a first top fold line 268. An engagement slot 270 formed through the material of the blank is disposed between the front wall 246 and the closing flap 266.

A top wall 272 is hingedly attached to the rear wall 250 along a second top fold line 274. The top wall 272 includes an insertion flap 276 hingedly attached to the top wall 272 along a third top fold line 278. In a preferred approach, the top wall further includes a tab 280. A cut line 282 through the material of the blank is disposed between the insertion flap 276 and the tab 280. Although container 240 is shown with a single insertion flap 276 and a single engagement slot 270, multiple insertion flaps and multiple corresponding slots are possible.

The container 240 is a multi-configurable container such that various combinations of folds can produce various container dimensions with different wall heights and different container lengths. This is accomplished by providing multiple fold lines that permit portions of the blank 242 to remain as part of the bottom wall 244, or to fold up as part of the left sidewall 248 and the right sidewall 252.

More specifically, the blank 242 is provided with a first left fold line 284 and corresponding first front left fold line 286 and first rear left fold line 288. The blank 242 is further provided with a second left fold line 290 and corresponding second front left fold line 292 and second rear left fold line 294. The blank 242 is further provided with a first right fold line 296 and corresponding first front right fold line 298 and first rear right fold line 300. The blank 242 is further provided with a second right fold line 302 and corresponding second front right fold line 304 and second rear right fold line 306. With this approach, all the fold lines mentioned immediately above are preferably score lines with perforations. If the blank is made from a paperboard material, the fold lines will be partial cuts or combinations thereof. The remaining fold lines in the blank may also be score lines, score lines with perforations, partial cuts or combinations thereof.

In a first configuration, the container 240 is folded along the first left fold line 284 and the first right fold line 296 such that the left sidewall 248 and right sidewall 252 are each pushed upwardly from a flat position to an upright position. Pushing the left sidewall 248 upwardly about the first left fold line 284 in turn causes the respective left sidewall connecting portions to fold at the first front left fold line 286 and first rear left fold line 288. Pushing the right sidewall 252 upwardly about the first right fold line 296 in turn causes the respective right sidewall connecting portions to fold at the first front right fold line 298 and first rear right fold line 300. This results in a first container bottom length (indicated as BL1 in FIG. 18). For example, a container 240 in the first configuration may have a bottom length of 6.25 inches.

In a second configuration, the container 240 is folded along the first left fold line 284 and the second right fold line 302 such that the left sidewall 248 and right sidewall 252 are each pushed upwardly from a flat position to an upright position. Pushing the left sidewall 248 upwardly about the first left fold line 284 in turn causes the respective left sidewall connecting portions to fold at the first front left fold line 286 and first rear left fold line 288. Pushing the right sidewall 252 upwardly about the second right fold line 302 in turn causes the respective right sidewall connecting portions to fold at the second front right fold line 304 and second rear right fold line 306. This results in a second container bottom length (indicated as BL2 in FIG. 18). For example, a container 240 in the second configuration may have a bottom length of 5.5 inches. A relatively shorter bottom length is dictated by the provision of taller sidewalls and taller front and back walls compared to the height of the same walls in the previous configuration.

In a third configuration, the container 240 is folded along the second left fold line 290 and the second right fold line 302 such that the left sidewall 248 and right sidewall 252 are each pushed upwardly from a flat position to an upright position. Pushing the left sidewall 248 upwardly about the second left fold line 290 in turn causes the respective left sidewall connecting portions to fold at the second front left fold line 292 and second rear left fold line 294. Pushing the right sidewall 252 upwardly about the second right fold line 302 in turn causes the respective right sidewall connecting portions to fold at the second front right fold line 304 and second rear right fold line 306. This results in a third container bottom length (indicated as BL3 in FIG. 18). For example, a container 240 in the third configuration may have a bottom length of 4.75 inches. This shorter bottom length is dictated by the provision of even taller sidewalls and taller front and back walls compared to the height of the same walls in the previous configuration.

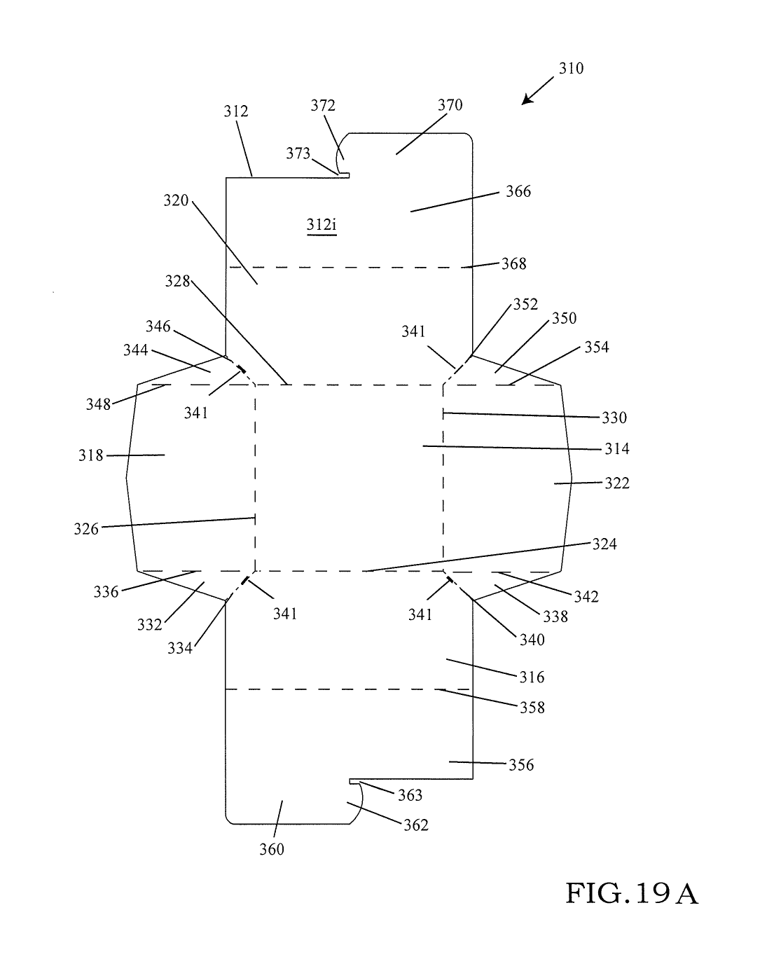

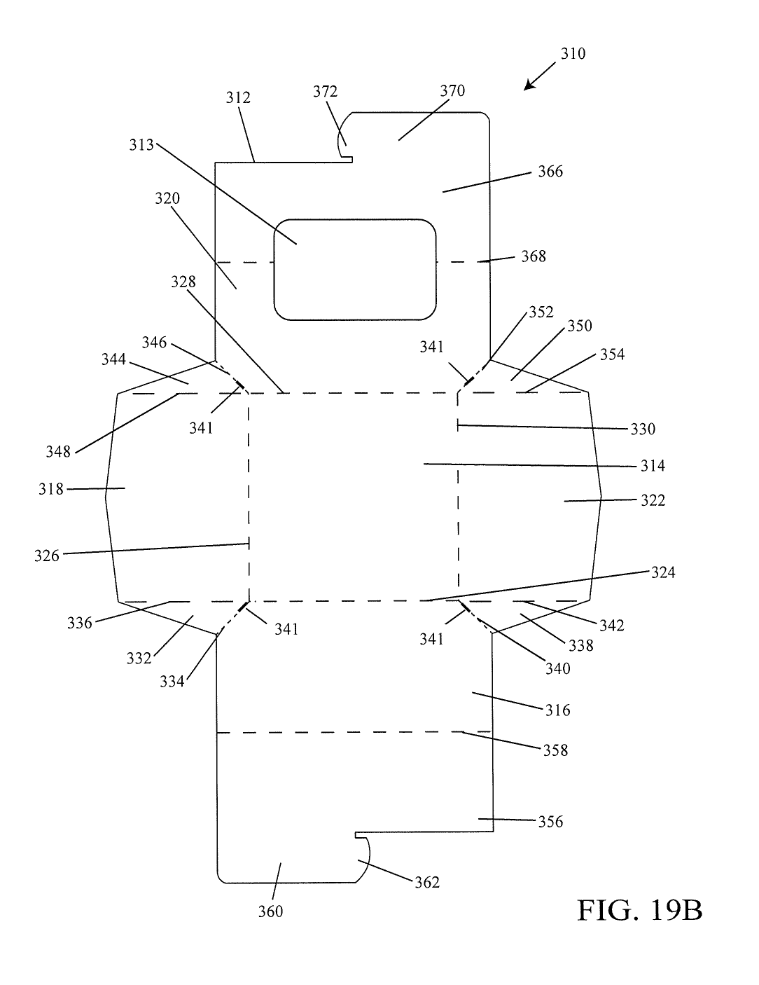

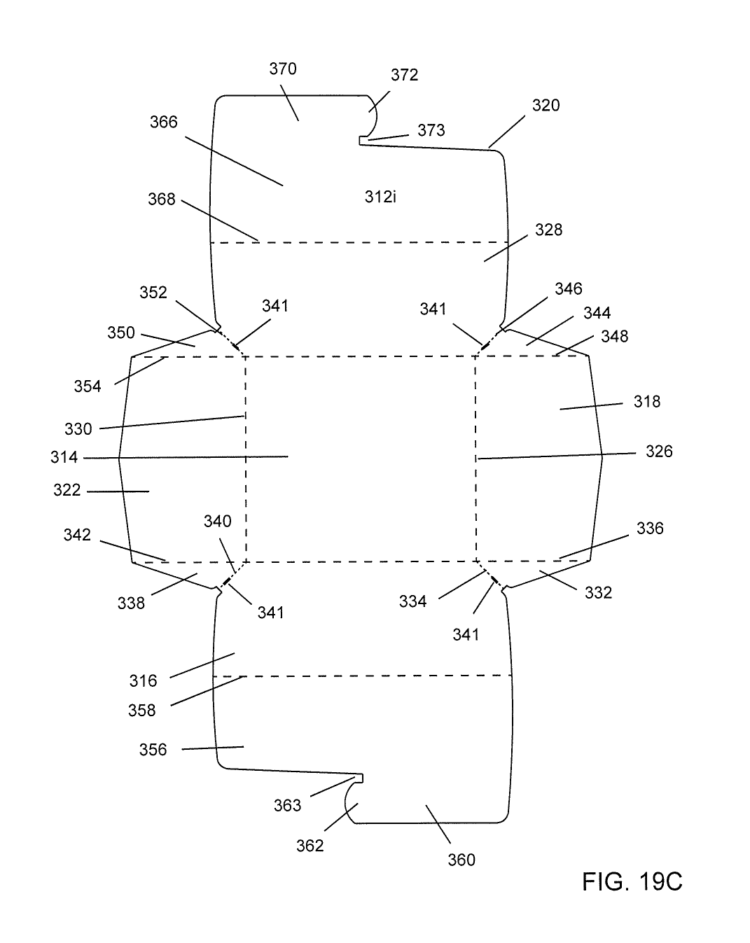

FIG. 19A illustrates a sixth embodiment of a food container 310 of the invention. The die cut blank used to form container 310 is similar to the die cut blank used to form container 10 shown in FIGS. 1-6. Elements in FIG. 19A having the last two digits that match an element in FIGS. 1-6, should be understood to operate in the same manner as the corresponding element in FIGS. 1-6 except where explicitly differentiated. In operation the container 310 folds in the same manner as the container 10. The key difference between container 310 and container 10 is that certain fold lines of the blank 312 are a combination of counter-plate scores and reverse counter-plate scores. In the previously described embodiments of FIGS. 7-11B, all of the score lines that defined the perimeter of the bottom wall and the other walls were score lines with perforations. Counter-plate scores and reverse counter-plate scores present another methodology for overcoming the built in memory of the paper material of the blank and which aid in the folding of the walls into a final, assembled container 310 without the need to pre-break various score lines as a means of reducing the potential for renegade fold lines to form which could obstruct the automatic assembly of the container. Counter-plate scores are formed on one side of the blank while reverse counter-plate scores have a reverse configuration, being formed on the opposite side of the blank. Each type of scoring is similarly formed, just on opposite sides of the blank. A counter-plate scoring is also directional in that they are made to fold in a specific direction, which makes the fold lines in the flat blank 312 much more flexible in a desired direction. The specific type of score used on each fold line is described in greater detail below.

The container 310 is formed from a single unitary blank 312, preferably of corrugated paper of the types previously described or paperboard. For example, the blank 312 may be formed of a double-faced “F” flute sheet, but this embodiment should not be considered to be limited to only this type of material. The inner surface 312i of the container 310 shown in FIG. 19A is a single face of material attached to a fluted medium. The outer surface, not shown, is a second face of material attached to the other side of the fluted medium. This embodiment is considered to be a single walled material and the invention is not to be limited as such since a single faced and/or double walled material or paperboard can also be used to form the blank. No matter the type of material, it is important to understand that all versions of this embodiment will preferably be shipped and formed from a planar blank. This approach generally increases manufacturing, shipping, and/or storage efficiencies as compared to containers that are first manufactured into various types of pre-formed containers such as clamshells and which cannot be returned to a planar state unless the package is destroyed at the areas within the top and bottom portions which are glued together.

The container 310 includes a bottom wall 314, a front wall 316, a left sidewall 318, a rear wall 320, and a right sidewall 322, all walls directly or indirectly interconnected by fold lines or living hinges. The bottom wall 314 of the container 310 has a generally flat configuration for stably resting on a flat surface, such as a table. The front wall 316 is hingedly attached to the bottom wall 314 along a first bottom fold line 324. The left sidewall 318 is hingedly attached to the bottom wall 314 along a second bottom fold line 326. The rear wall 320 is hingedly attached to the bottom wall 314 along a third bottom fold line 328. The right sidewall 322 is hingedly attached to the bottom wall 314 along a fourth bottom fold line 330. The bottom fold lines 324, 326, 328, and 330 are each intentionally provided as counter-plate scores. A counter-plate score is a special type of scoring that is configured to promote improved folding of the material of the blank in a single direction compared to perforated scoring or simple scoring, as will be explained below.

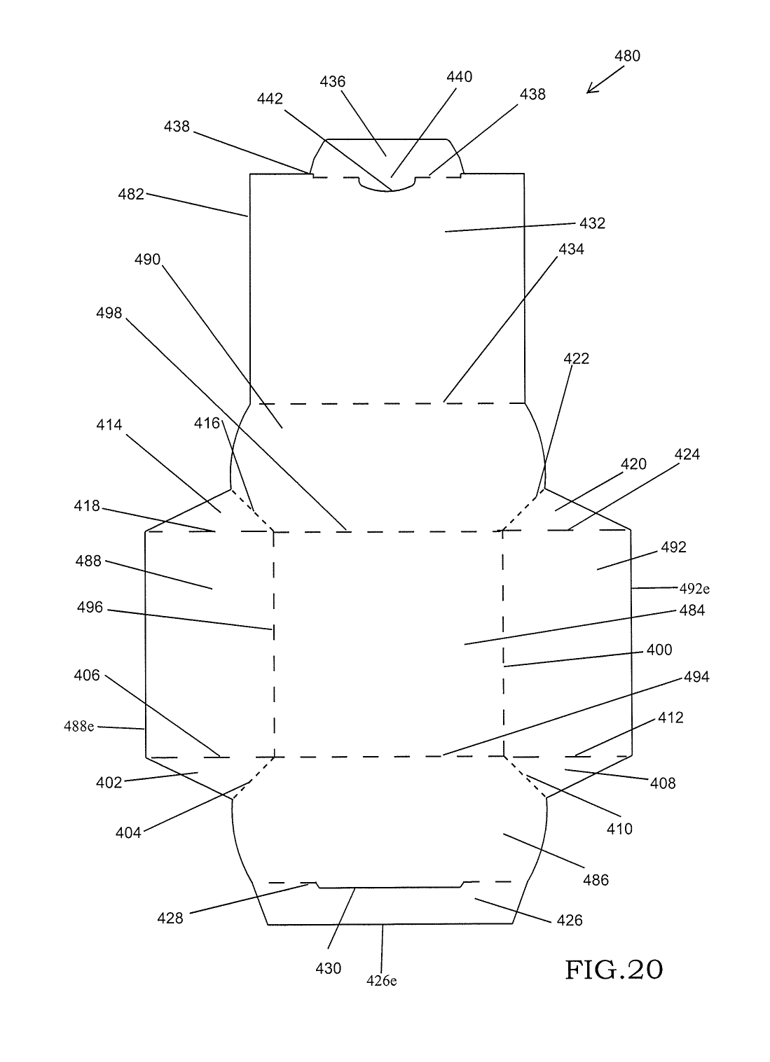

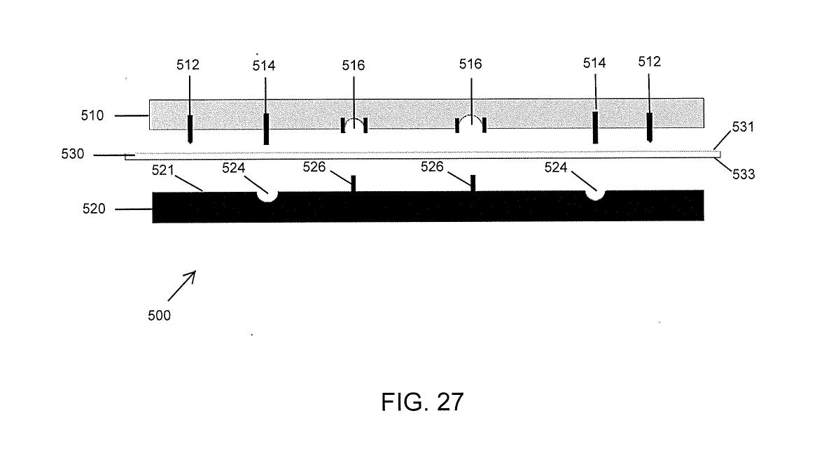

FIG. 27 illustrates a cross section of a die cutter 500 of the type that is used to form a desired container pattern in a blank and to score the blank in a manner that will result with the embodiments of the invention shown in FIGS. 19A-19C and 20. The die cutter 500 comprises a die 510 and a counter-plate 520, collectively configured to cut and score a blank 530 in a particular manner that is different from the container blanks that were previously described. The die 510 includes cutting blades 512 and scoring blades 514. The cutting blades 512 appear in FIG. 27 as separate, distinct components, but it should be understood that each of these knife-like blades form a part of a single, continuous cutting blade component. FIG. 27 shows the cutting blades 512 as being horizontally displaced from each other and positioned across from a flat portion of the counter-plate 520. However, because the cutting blades are part of a single, continuous cutting blade, they will completely pierce through and cut the material of a blank in that area to form and define the perimeter edge of a container blank which will eventually be assembled into a container of the invention. The scoring blades 514 on the other hand are blunt-edged blades that are not intended to cut through the material of the blank but are designed to forcibly crush the material of the blank into a special type of fold line. They are positioned across from arcuate channels 524 that are formed into the surface 521 of counter-plate 520. When the die 510 and counter-plate 520 are pressed together under pressure, the material of the blank is completely severed by the knife edges of cutting blades 512 when they contact top surface 521. Simultaneously, the material of the blank is counter-plate scored in select locations on the blank by the scoring blades 514. Counter-plate scoring involves pushing each of the blunt scoring blades 514 into contact with the first surface 531 of the blank 530. The first surface 531 is then collapsed into contact with second blank surface 533 whereby all of the material between and including surfaces 531,533, is collectively crushed under the pressure of the scoring blades 514 projecting downwardly into the arcuate channel 524 formed in the surface 521 of the counter plate 520. The material of blank 530 that is being forced into the arcuate channel 524 by scoring blades 514 is not torn or perforated, but rather is crushed and pressed together so as to form a bubble-like protuberance that projects off the second face 533 of the blank material once the blank is removed. Likewise, surface 531, which will later become the inside surface of an assembled container, will appear to have a bubble-like depression in that same area of the blank. The depth and width of an arcuate channel must be tailored to the type of material of the blank. For example, with a stiffer, paperboard material, the width of the channel may be wider to overcome the inherent memory of the material and to induce folding, whereas with a softer and more pliable fluted, single face material, the width may be narrower in order to accomplish the same results. With either material, the depth of arcuate channel 524 must be controlled so that the material does not rip or tear while being forced into the channel as described above.

The die 510, used to form the fold lines of the blanks of this embodiment described herein, can be used to cut and score the variety of other materials which were described earlier herein. As shown in FIG. 19A, the fold lines 324, 326, 328, and 330 are counter-plate scored such that the bottom wall 314 on the interior side of an assembled container will appear as a bubble-like depression in the material of the blank, while the outside surface of the blank will appear as a bubble-like protuberance.

The front wall 316 is connected to the left sidewall 318 via a first connecting portion 332. The first connecting portion 332 is hingedly attached to the front wall 316 along a first side fold line 334, which is a counter-plate scored and is hingedly attached to the left sidewall 318 along a second side fold line 336, which is a reverse counter-plate score. A reverse counter plate score is formed exactly like a counter-plate score except that the material of the blank will be crushed and pressed such that the bubble-like depression and bubble-like protuberance will be located on opposite sides of the blank from that which was formed with a counter-plate score. This aspect is understood by again viewing FIG. 27, where it is seen that die 510 is provided with arcuate channels 516 and the counter plate is provided with the scoring blades 526 to form areas on the blank with reverse counter-plate scores. The cooperative function of scoring blades 526 within arcuate channel 516 is exactly as described above for forming a counter-plate scoring, except inverted relative to the die 510. Again viewing FIG. 19A, it is seen that the front wall 316 is also connected to the right sidewall 322 via a second connecting portion 338. The second connecting portion 338 is hingedly attached to the front wall 316 along a third side fold line 340, which is a counter-plate score and is hingedly attached to the right sidewall 322 along a fourth side fold line 342, which is a reverse counter-plate score.

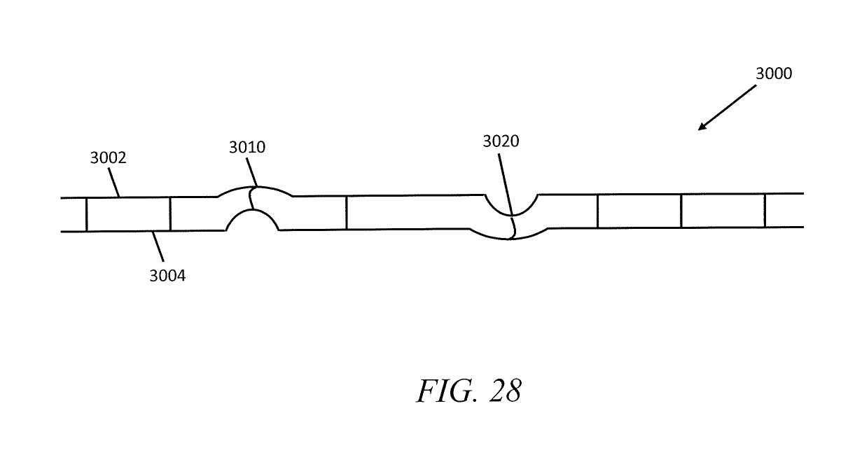

A cross section of a double faced substrate 3000 having a counter-plate score 3010 and a reverse counter-plate score 3020 is shown in FIG. 28. The counter-plate score 3010 comprises an indentation in the first face 3004 and a bubble in the second face 3002 as a result of the first face 3004 being crushed towards the second face 3002 by a blunt blade as described above. The reverse counter-plate score 3020 has a reverse configuration from the counter-plate score 3010, the reverse counter-plate score 3020 comprises an indentation in the second face 3002 and a corresponding bubble in the first face 3004. The reverse counter-plate score is formed by the crushing of the second face 3002 towards the first face 3004 as described above.

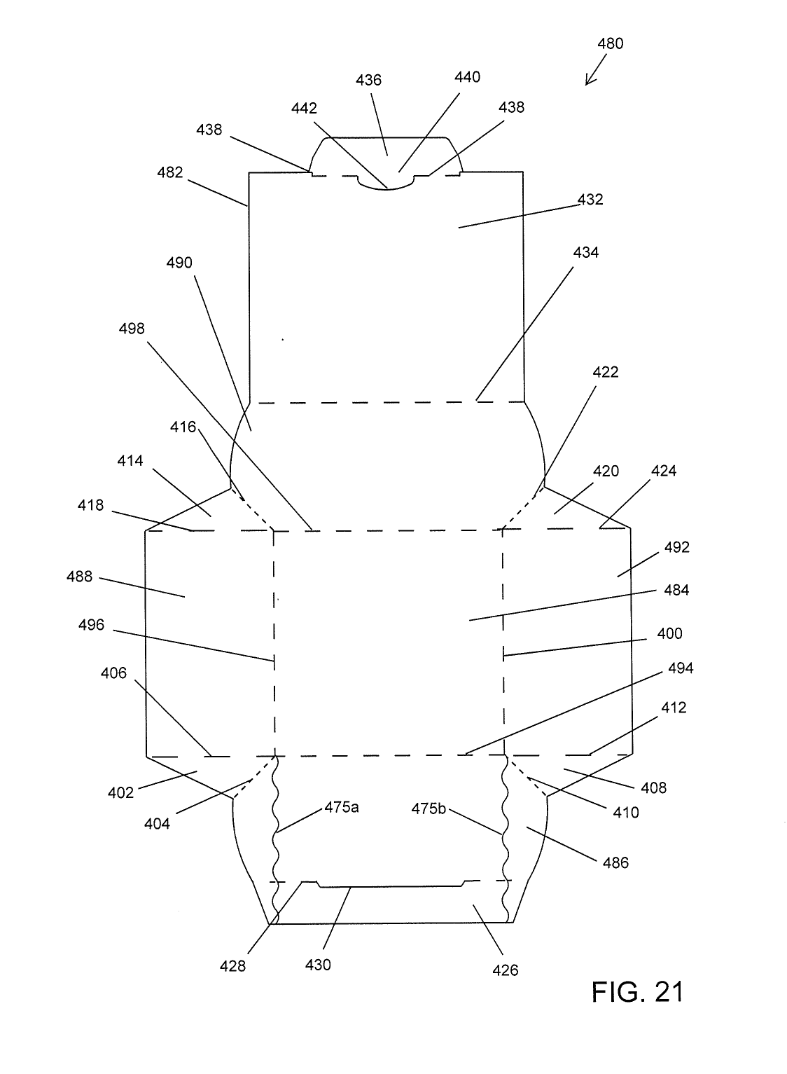

Returning to FIG. 19A, the rear wall 320 is connected to the left sidewall 318 via a third connecting portion 344. The third connecting portion 344 is hingedly attached to the rear wall 320 along a fifth side fold line 346, which is a counter-plate score and is hingedly attached to the left sidewall 318 along a sixth side fold line 348, which is a reverse counter-plate score. The rear wall 320 is also connected to the right sidewall 322 via a fourth connecting portion 350. The fourth connecting portion 350 is hingedly attached to the rear wall 20 along a seventh side fold line 352, which is a counter-plate score and is hingedly attached to the right sidewall 322 along an eighth side fold line 354, which is a reverse counter-plate score. In an assembly or dis-assembly operation, the counter-plate scores 334, 340, 346, and 352 allow the connecting portions 332, 338, 344, and 350 to fold in a manner such that they project away from the interior of the bottom portion of the container. The fold lines 336, 342, 348, and 354 form an inside corner of the bottom portion of the container. These sets of uniform counter-plate and reverse counter-plate score lines which define each connecting portion will all fold in a respective direction without the formation of renegade fold lines. FIG. 3 shows a container blank that has an exact profile to that of the blank shown in FIG. 19A, except with different scoring throughout the blank. Because of that similarity, FIG. 3 is useful for showing how the connecting portions 332, 338, 344, and 350, of the present embodiment fold at each corner of the blank and away from the interior of the container. Due to the unique combination of scoring, this embodiment of the invention will assemble without the container experiencing the formation of a renegade fold line. With a container package blank made from a fluted material, it is desirable to form as many of the larger, more critical fold lines, in the opposite direction that the flutes are extending rather than perpendicular thereto. It has been found that such an arrangement of fold lines will allow the container of the invention to assemble much easier. However, in some instances, it was also discovered that when a fold line is parallel to the flute direction, unintended, renegade fold lines may appear. In FIG. 21, the erratic lines identified at 475a and 475b represent unintended or renegade fold lines. It has been found that in some rare instances, especially when the entire container is not intentionally provided with counter-plate and reverse counter-plate fold lines, one or more renegade fold lines might appear when the container blank is initially assembled into its final configuration. The renegade fold lines 475a-b are aesthetic blemishes appearing in the outside surface of the container. Renegade fold lines sometimes form as an extension of the fold line scoring that is provided within a blank, as presented in FIG. 21, or sometimes they appear as a faint fold line alongside or parallel to a score line that has been provided. These involuntary fold lines result from the fibers of the paper stock of the blank adjacent to a fold line not having the strength to resist the bending forces encountered within a score line once a container wall is folded along the score line. Alternatively, or contributing to their formation, renegade fold lines sometimes form due to a particular part of the blank not providing sufficient surface area to distribute the bending forces. Nevertheless, renegade fold lines do not prevent the container of the invention from automatically folding and assembling itself.

In some forms, the fold lines 334, 340, 346, and 352 further include the perforation 341 as described and shown in FIG. 19A, perforations are cuts into the surface of the blank 312. A perforation 341 can extend partially or entirely through the thickness of the chosen material of the blank 312. The perforations 341 further reduce the likelihood of unintentional, renegade folding of the blank 312 about places other than the actual fold lines. The perforations 341 can comprise a single perforation centered along the extent of the fold line, as shown, or can comprise a plurality of perforations spaced along the length of the respective fold line. These perforations can be added to the oblique fold lines of any of the other embodiments in order to reduce the likelihood of renegade fold lines.

It is seen that first top wall 356 is hingedly attached to the front wall 316 along a first top fold line 358. The first top wall 356 includes a first extension region 360 having a first engagement tab 362. In alternative approaches, the first engagement tab 362 is hingedly attached to the first extension region 360 along a first tab fold line, similar to first tab fold line 64 in FIG. 1. The engagement tab 362 of first extension region 360 also defines a first engagement slot 363. A second top wall 366 is hingedly attached to the rear wall 320 along a second top fold line 368. The second top wall 366 includes a second extension region 370 having a second engagement tab 372. In alternative approaches, the second engagement tab 372 is hingedly attached to the second extension region 370 along a second tab fold line, similar to second tab fold line 74 in FIG. 1. The engagement tab 372 of second extension region 370 also defines a second engagement slot 373.

Each of the fold lines 358 and 368 can be counter-plate scores to provide the hinged attachment as described above, but more importantly to bias the hinges towards only folding in one direction, that towards the bottom wall 314 when assembling the blank into a finished container.

It has been found that with this embodiment, the inclusion of the counter-plate and reverse counter-plate fold lines in the above-described blank 312, the walls and connecting portions of the blank 312 will more readily rotate (i.e., fold) about the fold lines in the directions described above, making the construction of the container 310 from the blank 312 quicker and easier for a user and without the formation of renegade fold lines. Furthermore, due to the addition of the said fold lines, construction of the container 310 may be performed entirely at the hands of the user without the need to resort to a forming fixture or other external forming aids or the need to consider pre-breaking of the fold lines prior to shipping the blank. This arrangement of counter-plate and reverse counter-plate scoring thus allows the removal of manufacturing process steps that introduce pre-breaking or pre-folding of some or all of the score lines of the containers 310 as a means of reducing the risk that renegade fold lines will be formed.

Advantageously, due to the aforementioned configuration of the scoring on the blank 312 as described above, the upwardly pivoting of both side walls 318 and 322 with respect to the bottom wall 314 effects simultaneous pivoting of the front and rear walls 316, 320 with respect to the bottom wall 314. This automatic pivoting of walls 318 and 322 is the result of each sidewall being connected to an adjacent front or rear wall through a common connecting portion there between. Thus, for example, when side wall 318 is upwardly pushed or pivoted about bottom fold line 326, and side wall 322 is simultaneously pushed upwardly or pivoted about bottom fold line 330, side wall 318 pulls the first connecting portion 332 from a flat position to an upright position and first connecting portion 332, in turn, simultaneously pulls front wall 316 from a flat position to an upright position. Likewise, the side wall 322 is pulling on the second connecting portion 338, which in turn also contributes in pulling the front wall 316 from a flat position to an upright position. In the same fashion, left sidewall 318 and right sidewall 322, simultaneously pull the rear wall 320 from a flat position to an upright position via the third connecting portion 344 and the fourth connecting portion 350, respectively. Thus, the and the interconnection of the walls to the various connecting portions as provided, allows for the simultaneous interaction of each of the walls and an automatic folding of the blank 312 into an assembled condition, which further expedites the construction of the container 310 for the user, all without forming aids and/or the need for glues or tapes. The simultaneous folding of the sidewalls and the front and back walls also causes the first and second top walls 356 and 366 to be pulled upwardly relative to bottom wall 314 such that each top wall is in a position that is perpendicular to the bottom wall 314 until each respective top wall 356, 366, is folded downwardly and inwardly along a respective score line 358 and 368 towards bottom wall 314. The top walls 356, 366 are then locked together by the interaction of the first and second engagement tabs 362, 372 within the first and second engagement slots 363, 373, similar to the interlocking that is shown in FIG. 4. When the top walls 356, 366 are locked, the container is in a fully assembled condition without the use of forming devices or glue. Advantageously, the container can be dis-assembled by unlocking the top engagement tabs and then pushing all of the walls downwardly to a flat position relative to the bottom wall 314 so that the container can be used as a sanitary serving plate.

In addition, the blank 312 of this embodiment is provided with a non-angled top edge that dictates extension portions 360, 370 have a rectangular shape. In some embodiments, the container 310 may have extension portions 360, 370 that are shaped similar to the extension portions 60, 70 that were presented in FIGS. 1-4. In further embodiments, container 10, as shown in FIGS. 1-4 may have extension portions 60, 70 shaped like extension portions 360 and 370.

FIG. 19B shows another form of the sixth embodiment of the invention that was shown in FIG. 19A. This form can also be applied to all of the earlier embodiments. There, it is seen that a window 313 has been cut into the blank 312 that will be covered with a clear plastic film (not shown) to allow a customer to view the contents within the container. The window 313 is shown cascading from the top wall 366 to the rear wall 320, however, the same arrangement could have been provided in the top wall 356 and the front wall 316.

FIG. 19C shows another form of the sixth embodiment of the invention that was shown in FIG. 19A. This form can also be applied to all earlier embodiments. It is seen that the connecting portions 332, 344, 350, 338, the front wall 316, and the back wall 328 have been rounded. The rounding of the front wall 316 and the back wall 328 continues onto the top portions 356 and 366 so as to form a continuous arc. Cutouts have been made along the outer perimeter of the blank 312 at the fold lines 334, 346, 352, 340 to provide space for the rounded pieces to fit together. This rounding is purely aesthetic. It provides a softer look to the erected container with rounded sides instead of corners.

FIG. 20 illustrates a seventh embodiment of a food container of the invention, hereinafter identified to as the container 480. The profile of the die cut blank that is used to form container 480 is similar to the profile of the die cut blank used to form container 40 shown in FIGS. 7-11B. Elements in FIG. 20 having the same last two digits as an element in FIGS. 7-11B should be understood to operate in the same manner as the corresponding element in FIGS. 7-11B except where explicitly differentiated. In operation, the container 480 ultimately folds up in the same manner as the container 80 shown in FIGS. 8 and 9. One key difference between container 480 and container 80 is that certain fold lines of container 480 are created using counter-plate scores and reverse counter-plate scores instead of the perforated score lines in the embodiments shown in FIGS. 7-11B, in order to overcome the “memory” inherent within the paper material of the die cut blank and to prevent the formation of renegade fold lines.

Referring again to FIG. 20, fold lines 406, 412, 418, and 424 are reverse counter-plate scores and these fold lines will form the inner corners of the container 480 when the blank 482 is assembled into a finished container. All other fold lines, e.g., 438, 434, 498, 416, 422, 496, 400, 494, 404, 410, and 428 in the die cut blank 482 are counter-plate scores. As provided with the container 310 described above, fold lines 404, 410, 416, and 422, may include one or more perforations. The perforations further reduce the likelihood of unintentional folding (renegade folding) of the blank 482 about places other than the actual fold lines in the same manner as presented in FIG. 21. The perforations can comprise a single perforation centered along the extent of the fold line or can comprise a plurality of perforations spaced along the length of the respective fold line as shown.

Another difference between the blank 482 and the blank 82 of FIGS. 7-11B is found in the insertion flap 436 and the cut line 442. In this embodiment, the fold line 438 is provided with the centrally disposed cut 442 that form a tab 440 which curves towards the bottom wall 484. When the top wall 432 is folded down during assembly to lock the top wall to the bottom portion of the container, the flap 440 extends upwards away from the bottom wall 484 of the blank 482 in a perpendicular fashion, which readily allows a user to pull up on the upwardly projecting tab so as to unlock the top wall. Additionally, and more importantly, the front wall 486 is provided with additional material on the left and right sides in to make it laterally wider in the areas around the connecting portions, best seen in the drawing as having a curved profile on each lateral side of the front wall near connecting portions 402 and 408. The curve of the laterally wider front wall extends upwardly to meet a fold line 428, thereby adding additional material to the closing flap 426 too. The laterally wider closing flap 426 allows it to rest upon the top edges 488e and 492e of sidewalls 488 and 492 when the container is closed, whereas with the previous embodiments of FIGS. 7-11B, the closing flap did not rest on the edges of the sidewalls when closed. In this way, when the walls are upwardly folded towards the bottom wall of the container, the added material around the front wall connecting portions 402,408 will ensure that renegade fold lines will not form in the front wall 486 in the area between fold lines 494 and edge 426e or within a fold line associated with either connecting portion. Furthermore, when top wall 432 is folded downwardly to close the container, the closing flap 426 is now resting upon and extending beyond the top edges 488e and 492e, thereby providing better stabilization of the front wall 486 and top wall 432 after top wall 432 is locked to it after insertion flap 436 is inserted within insertion slot 430. In all other respects, the die cut blank of the embodiment shown in FIG. 20, operates like the embodiment shown in FIG. 19 when assembling and dis-assembling the blank into a folded and unfolded container.

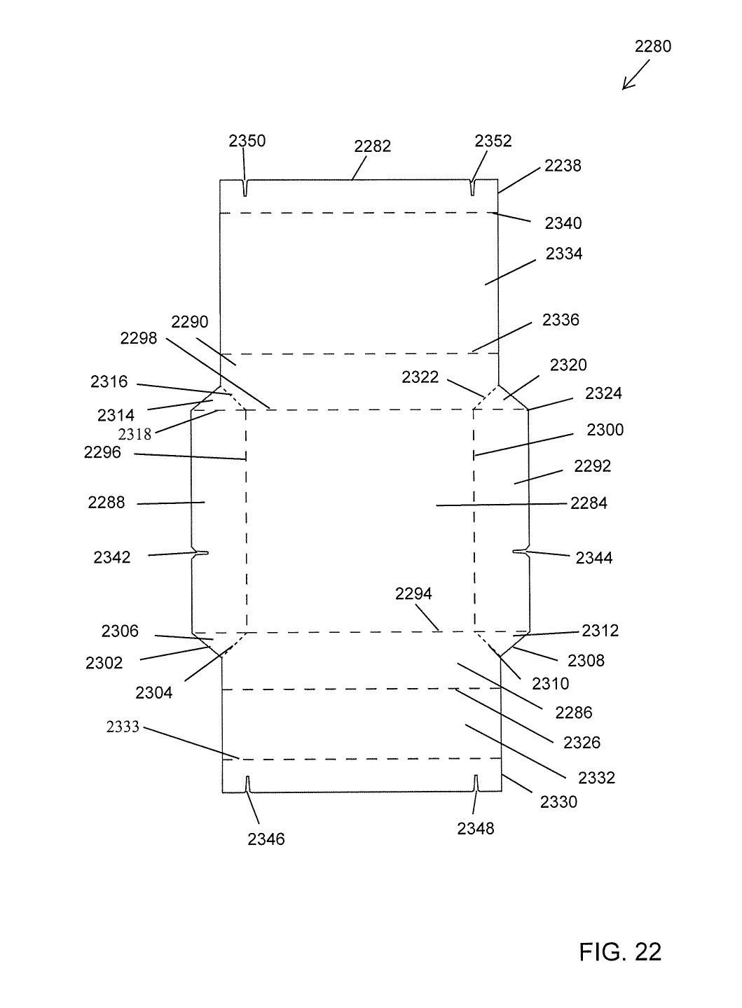

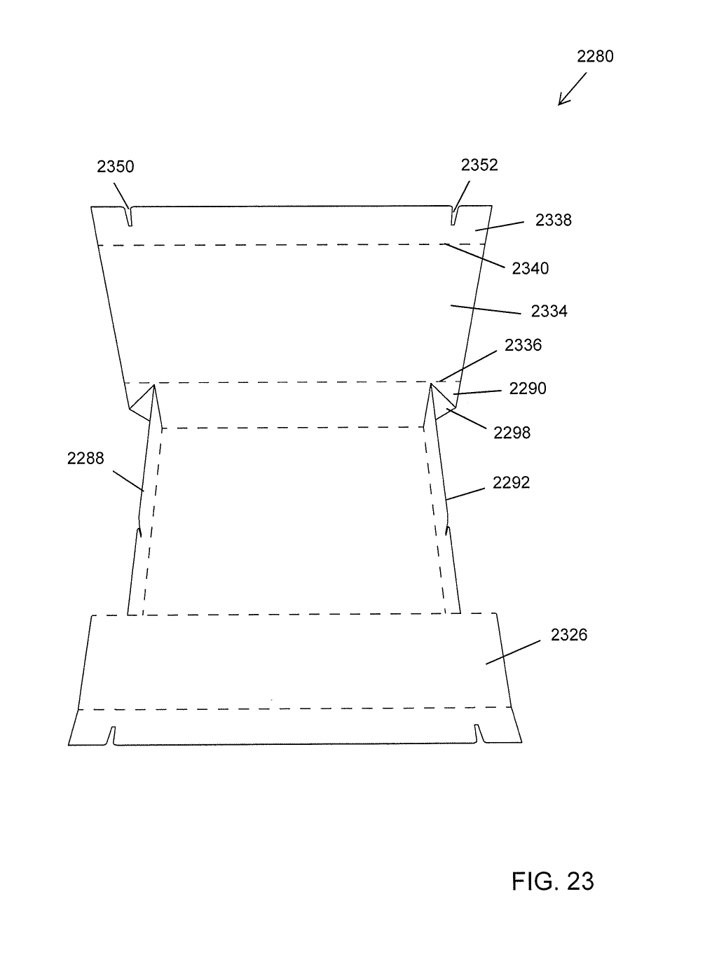

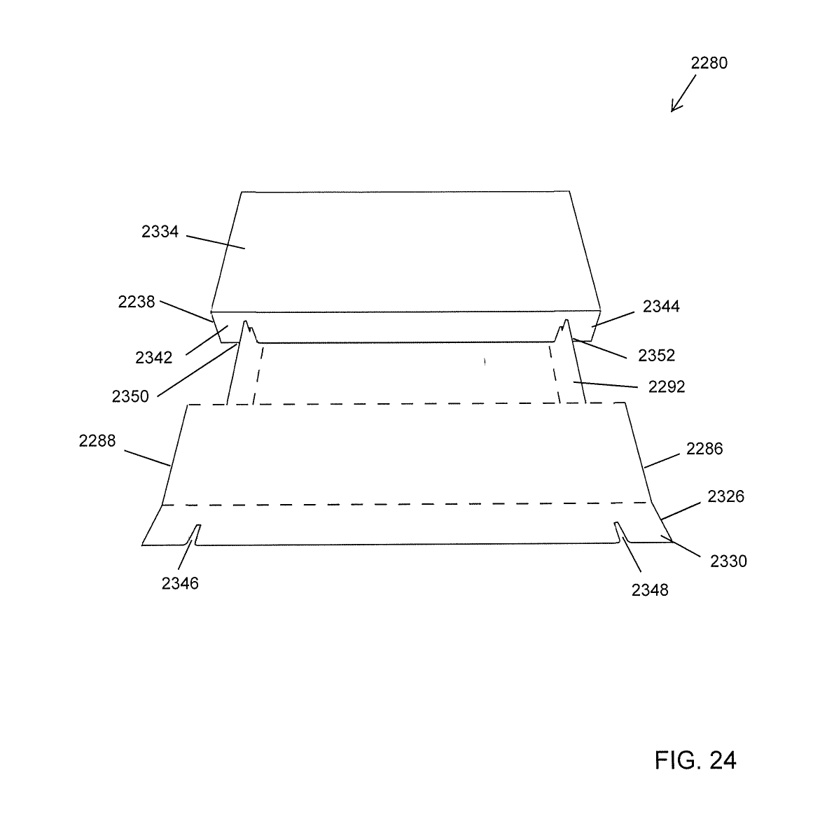

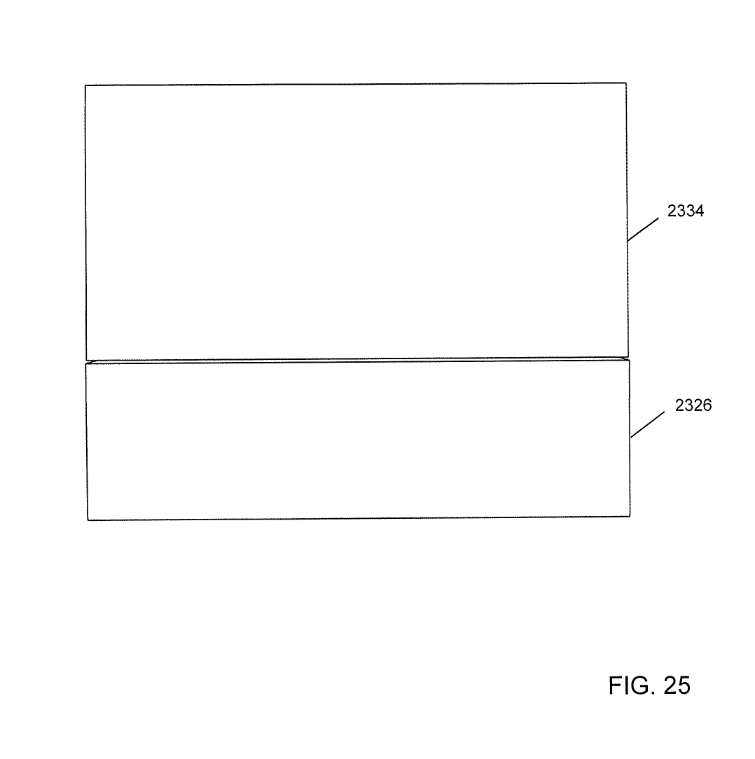

FIGS. 22-26 illustrate an eighth embodiment of a food container 2280, hereinafter referred to as the container 2280. Container 2280 includes many of the features and attributes of the previously-described containers. For the sake of brevity, some such features and attributes may not be repeated.

As shown in FIG. 22, the container 2280 is formed from a single unitary blank 2282, preferably of corrugated paperboard or paperboard. The container 2280 includes a bottom wall 2284, a front wall 2286, a left sidewall 2288, a rear wall 2290, and a right sidewall 2292 interconnected by fold lines or living hinges. The bottom wall 2284 of the container 2280 has a generally flat configuration for stably resting on a flat surface, such as a table. The front wall 2286 is hingedly attached to the bottom wall 2284 along a first bottom fold line 2294. The left sidewall 2288 is hingedly attached to the bottom wall 2284 along a second bottom fold line 2296. The rear wall 2290 is hingedly attached to the bottom wall 2284 along a third bottom fold line 2298. The right sidewall 2292 is hingedly attached to the bottom wall 2284 along a fourth bottom fold line 2300.

In another approach, each bottom fold line 2294, 2296, 2298, 2300 includes perforations through the thickness of the blank 2282. The perforations may be regularly or irregularly spaced along the fold lines 2294, 2296, 2298, 2300. Other combinations of fold lines, cutting and perforations are possible, as previously described.

The front wall 2286 is connected to the left sidewall 2288 via a first connecting portion 2302. The first connecting portion 2302 is hingedly attached to the front wall 2286 along a first side fold line 2304, and is hingedly attached to the left sidewall 2288 along a second side fold line 2306. The front wall 2286 is connected to the right sidewall 2292 via a second connecting portion 2308. The second connecting portion 2308 is hingedly attached to the front wall 2286 along a third side fold line 2310, and is hingedly attached to the right sidewall 2292 along a fourth side fold line 2312.

The rear wall 2290 is connected to the left sidewall 2288 via a third connecting portion 2314. The third connecting portion 2314 is hingedly attached to the rear wall 2290 along a fifth side fold line 2316, and is hingedly attached to the left sidewall 2288 along a sixth side fold line 2318. The rear wall 2290 is connected to the right sidewall 2292 via a fourth connecting portion 2320. The fourth connecting portion 2320 is hingedly attached to the rear wall 2290 along a seventh side fold line 2322, and is hingedly attached to the right sidewall 2292 along an eighth side fold line 2324.

A first top wall 2332 is hingedly attached to the front wall 2286 along a first top fold line 2326. A first divider wall 2330 is hingedly attached to the first top wall 2332 along a first divider fold line 2333.

A second top wall 2334 is hingedly attached to the rear wall 2290 along a second top fold line 2336. A second divider wall 2238 is hingedly attached to the second top wall 2334 along a second divider fold line 2340.

Similar to containers of the previous embodiments, container 2280 is configured such that pivoting one side wall of the container 2280 with respect to the bottom wall 2284 effects pivoting of one or more other side walls with respect to the bottom wall 2284. Furthermore, no glue is necessary to maintain the container 2280 in the constructed form. Container 2280 is also configured such that it is easily collapsible into a substantially flat sheet for subsequent use as a sanitary eating surface. Other advantages of the containers of the previous embodiments are similarly applicable to container 2280.

The container 2280 provides for two separate compartments when in the closed position. The first compartment is formed by the bottom wall 2284, the front wall 2286, the left sidewall 2288, the right sidewall 2292, the first divider wall 2330, and the first top wall 2326. The second compartment is formed by the bottom wall 2284, the rear wall 2290, the left sidewall 2288, the right sidewall 2292, the second divider wall 2338, and the second top wall 2334.

The two compartments held in the closed position by a plurality of interlocking notches. More specifically, a notch 2342 of the left sidewall 2288 and a notch 2344 of the right sidewall 2292 together receive and frictionally engage corresponding notches 2346, 2348 of the first divider wall 2330. Upon notch 2342 fully engaging notch 2346, and notch 2344 fully engaging notch 2348, the first top wall 2332 and the first divider wall 2330 are held in the closed position, thereby creating the first compartment.

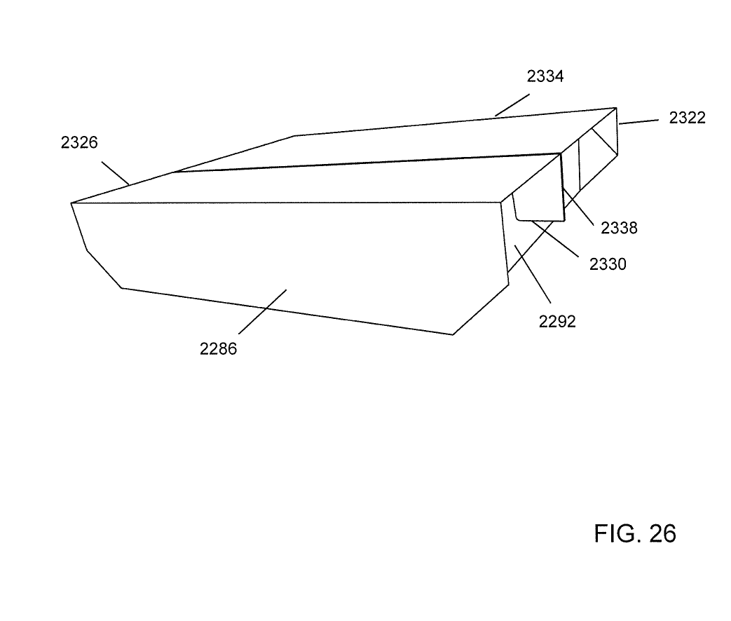

Similarly, the notch 2342 of the left sidewall 2288 and the notch 2344 of the right sidewall 2292 together receive and frictionally engage corresponding notches 2350, 2352 of the second divider wall 2338. Upon notch 2342 fully engaging notch 2350, and notch 2344 fully engaging notch 2352, the second top wall 2334 and the second divider wall 2338 are held in the closed position (shown in FIG. 26), thereby creating the second compartment.

The dual-compartment design of the container 2280 allows for separation of food items, and reduces the risk of mixing food items that are intended to be kept separate.

As previously discussed, it has been found that the inclusion of fold lines, and preferably counter-plate fold lines, in the above-described blanks aids in overcoming the “memory” of the blank. In this regard, the above-described blanks may be formed using a die cutting system that includes a cutting die and a counter-plate. The cutting die includes cutting blades and adjacent ejectors. The ejectors are formed of foam, rubber, or other suitable ejection material. The cutting die also includes score rules. Preferably, the cutting die also includes perforation blades that include protrusions extending therefrom. Counter-plates include planar receiving surface and a plurality of grooves. In some approaches, one or more of the plurality of grooves includes notches for receiving the protrusions of the perforation blades of the cutting die.

The cutting die and one or more counter-plates are aligned in the die cutting system such that the grooves of the counter-plates are positioned in alignment with the score rules and perforation blades of the cutting die. During manufacture of the blanks, a substrate (such as a sheet of fluted or non-fluted paperboard) is positioned between the cutting die and the counter-plates such that the substrate rests on the planar receiving surface of the counter-plates. The cutting die is pressed into the substrate such that the cutting blades cut through the entire thickness of the substrate to form outer perimeters of individual blanks. Score rules and perforation blades force portions of the substrate into the grooves of the counter-plates, thereby forming fold lines in the blanks. Protrusions of the perforation blades cut through the entire thickness of the substrate to form perforations in the fold lines.

The inclusion of counter-plate-formed fold lines in the above-described blanks aids users in forming containers by counteracting the inherent tendency of the blanks to resist folding. Such counter-plate-formed fold lines typically obviate the need for external folding fixtures at the time of construction of the container, thereby reducing costs, simplifying construction, and expediting construction time.

In each of the embodiments above, the front and rear walls extend past the side walls, and when the side walls are pivoted or folded upward, the front and rear walls automatically follow.

References to “top,” “bottom,” “front,” “bottom,” “left,” “right,” and other points of direction are for internal reference and are not intended to limit the orientation of the container in use. Skilled artisans will appreciate that elements in the figures are illustrated for simplicity and clarity and have not necessarily been drawn to scale.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. Any description of certain approaches or embodiments as “preferred” approaches or embodiments, and other recitation of approaches, embodiments, features, or ranges as being preferred, or suggestion that such are preferred, is not deemed to be limiting. The invention is deemed to encompass embodiments that are presently deemed to be less preferred and that may be described herein as such. All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

What is claimed is:

1. A box container comprising:
a bottom wall having outer perimeter edges;
a plurality of upstanding walls extending upwardly from respective edges of the bottom wall;
opposite front and rear walls of the upstanding walls;
opposite side walls of the upstanding walls; and
side projecting portions at either side of each of the front and rear walls that extend beyond the corresponding side walls.

2. The box container of claim 1 further comprising a connecting portion between each of the projecting portions and an adjacent one of the side walls with the connecting portion extending along the adjacent one of the front and rear walls.

3. The box container of claim 1 wherein the front and rear walls each have a main wall portion extending between the side walls generally perpendicular thereto with the projecting portions and the associated main wall portion together having a planar configuration so that the projecting portions are each perpendicular to an adjacent one of the side walls.

4. The box container of claim 1 wherein the bottom wall and upstanding walls are formed from a single blank.

5. The box container of claim 4 wherein the single blank includes upstanding wall fold lines along the bottom wall outer perimeter edges to allow the upstanding walls to be folded up about the fold lines,
connecting portions between each of the side projecting portions and the corresponding side wall, and
connecting portion fold lines between each of the connecting portions and the corresponding side wall and each of the connecting portions and the corresponding one of the front and rear walls, the upstanding wall fold lines being configured to allow one of the side walls to be folded up about the corresponding upstanding wall fold line causing the front and back walls to begin to fold up about the corresponding upstanding wall fold lines and causing the connecting portions adjacent the one side wall to fold about the connecting portion fold lines so that the connecting portion extends beyond the one side wall for extending along the adjacent projecting portion of the corresponding one of the front and rear walls when the upstanding walls are fully folded up for forming the box container.

6. The box container of claim 5 wherein the connecting portion fold line between each of the connecting portions and the corresponding side wall has a reverse configuration to that of a configuration of the connecting portions fold line between each of the connecting portions and the corresponding one of the front and rear walls and a configuration of the upstanding wall fold lines.

7. A box container comprising:
a bottom wall having outer perimeter edges;
a plurality of upstanding walls extending upwardly from respective edges of the bottom wall;
front and rear walls of the upstanding walls;
side walls of the upstanding walls;
a single blank from which all the walls are formed into the box container by folding of the single blank about fold lines formed in the blank including upstanding wall fold lines between the bottom wall and the upstanding walls; and
connecting portions between the front wall and the side walls and the rear wall and the side walls with the walls and connecting portions configured such that folding of one of the side walls about the upstanding wall fold line between the one side wall and the bottom wall causes the front and rear walls to also begin to fold upwardly about the upstanding wall fold lines between the front and rear walls and the bottom wall.

8. The box container of claim 7 wherein the fold lines include connecting portion fold lines between the connecting portions and the side walls and the connecting portions and the front and rear walls, with the folding of the one side wall causing the adjacent connecting portions to fold relative thereto about the connecting portion fold lines between the connecting portions and the one side wall to extend in a transverse direction thereto for extending along the respective front and rear walls when completely folded up about the upstanding wall fold lines between the front and rear walls and the bottom wall.

9. The box container of claim 7 wherein the front and rear walls extend between and beyond the side walls when the upstanding walls are completely folded up about the upstanding wall fold lines, and the folded connecting portions extend along the front and rear walls beyond the side walls.

10. The box container of claim 7 wherein the connecting portion fold lines between the side walls and the connecting portions have a reverse configuration relative to the connecting portion fold lines between the connecting portions and the front and rear walls.

11. The box container of claim 8 wherein the connecting portion fold lines between the connecting portions and the front and rear walls are oblique to the connecting portion fold lines between the side walls and the connecting portions.

12. The box container of claim 7 wherein the fold lines include connecting portion fold lines between the connecting portions and the side walls and the connecting portions and the front and rear walls, and each of the connecting portions lack fold lines intermediate the connecting portion fold lines thereof.

13. The box container of claim 7 wherein the side walls and front and rear wall when completely folded up from the bottom wall form an interior space having an upper opening,
and at least one top wall configured to cover the upper opening to close the interior space.

14. A method for forming a box container having a bottom portion, opposing upstanding side portions, and opposing upstanding end portions, the method comprising:
providing a blank including the side portions, the end portions, and the bottom portion with fold lines between the side portions and the bottom portion and the end portions and the bottom portion, the blank including connecting portions between the side portions and the end portions with fold lines therebetween;
folding one of the side portions to pivot up about the fold line between the one side portion and the bottom portion; and
the folding of the one side portion causing:
pivoting of at least the connecting portions adjacent to the one side portion relative to the one side portion about respective fold lines; and
pivoting of at least the end portions up about respective fold lines between the end portions and the bottom portion, the pivoting of the connecting portions causing the connecting portions to extend along the end portions when the box container is formed.

15. The method of claim 14 further wherein the fold lines between the one side portion and the connecting portions have a reverse configuration relative to the fold line between the one side portion and the bottom portion.

16. The method of claim 14 further comprising:
folding a top portion to pivot about a fold line between the top portion and at least one of the end portions; and
securing the folded top portion in a closed position to extend over an interior space formed by the upstanding side portions and end portions and the bottom portion, the folded top portion being secured in the closed position without use of adhesive.

17. A blank for forming a container, the blank comprising:
a first face;
a second face;
a first side wall portion, the first side portion being at least partially defined by a score wherein material forming the first face is indented towards the second face and a reverse score wherein the material forming the second face is indented towards the first face; and
a second side wall portion, the second side portion being at least partially defined by a score wherein material forming the first face is indented towards the second face and a reverse score wherein the material forming the second face is indented towards the first face.

18. The blank of claim 17 further comprising:
a front wall portion at least partially defined by a score wherein material forming the first face is indented towards the second face;
a back wall portion at least partially defined by a score wherein material forming the first face is indented towards the second face;
a first connecting portion coupled to the front wall portion and the first side wall portion, such that when the first side wall portion is folded about the score at least partially defining the first side wall portion, the first connecting portion causes the front wall portion to fold about the score at least partially defining the front wall portion; and
a second connecting portion coupled to the back wall portion and the first side wall portion, such that when the first side wall portion is folded about the score at least partially defining the first side wall portion, the second connecting portion causes the back wall portion to fold about the score at least partially defining the back wall portion.

19. The blank of claim 18 further comprising:
a third connecting portion coupled to the front wall portion and the second side wall portion, such that when the second side wall portion is folded about the score at least partially defining the second side wall portion, the third connecting portion causes the front wall portion to fold about the score at least partially defining the front wall portion; and
a fourth connecting portion coupled to the back wall portion and the second side wall portion, such that when the second side wall portion is folded about the score at least partially defining the second side wall portion, the fourth connecting portion causes the back wall portion to fold about the score at least partially defining the back wall portion.

20. The blank of claim 17, wherein the front wall portion extends beyond the side wall portions with the blank folded to have a box container configuration.

21. The blank of claim 18 wherein the first connecting area is adjacent to the reverse score of the first side wall portion.

22. A container blank comprising:
a bottom portion being defined on four sides thereof by a first, second, third, and fourth bottom score;
a first side portion at least partially defined by the first bottom score;
a second side portion at least partially defined by the second bottom score;
a front portion at least partially defined by the third bottom score;
a back portion at least partially defined by the fourth bottom score;
a first back connecting portion connecting the first side portion to the back portion, the first back connecting portion being defined by a side score connecting the first back connecting portion from the first side portion and a back score, oblique to the side score, connecting the first back connecting portion from the back portion, the first back connecting portion configured to pull the back portion to fold about the fourth bottom score when the first side portion is folded about the first bottom score;
a second back connecting portion connecting the second side portion to the back portion, the second back connecting portion being defined by a side score connecting the second back connecting portion from the first side portion and a back score, oblique to the side score, connecting the second back connecting portion from the back portion, the second back connecting portion configured to pull the back portion to fold about the fourth bottom score when the second side portion is folded about the second bottom score;
a first front connecting portion connecting the first side portion to the front portion, the first front connecting portion being defined by a side score connecting the first front connecting portion from the first side portion and a front score, oblique to the side score, connecting the first front connecting portion from the back portion, the first front connecting portion configured to pull the front portion to fold about the third bottom score when the first side portion is folded about the first bottom score; and
a second front connecting portion connecting the second side portion to the front portion, the second front connecting portion being defined by a side score connecting the second front connecting portion from the second side portion and a front score, oblique to the side score, connecting the second front connecting portion from the back portion, the second front connecting portion configured to pull the front portion to fold about the third bottom score when the second side portion is folded about the second bottom score.

23. The blank of claim 22 further comprising a top portion connected to the back portion by a top score.

24. The blank of claim 22 wherein the first, second, third, and fourth bottom scores are counter plate scores.

25. The blank of claim 22 wherein the side scores of the first back connecting portion, first front connecting portion, second back connecting portion, and second front connecting portions are reverse counter plate scores.

26. The blank of claim 22, wherein the front portion and back portion extend past the side portions when the blank is folded into an erected box container configuration.
